(19) United States
(12) Patent Application Publication
(10) Pub. No.: US 2026/0062502 A1
(43) Pub. Date: Mar. 5, 2026

(54) CELLULOSE ESTERS AND CELLULOSE ESTER FIBERS HAVING RECYCLED CONTENT FROM MULTIPLE SOURCES

(71) Applicant: Eastman Chemical Company, Kingsport, TN (US)

(72) Inventors: Trevor Hobbs Treasure, Kingsport, TN (US); John Michael Allen, Kingsport, TN (US); Neil Warren Boaz, Kingsport, TN (US); Brian Tyndall Edwards, Jonesborough, TN (US); Perry Michael Murdaugh, Johnson City, TN (US); Robert Lin, Kingsport, TN (US); Kevin Leonard Urman, Gonzalez, FL (US)

(73) Assignee: Eastman Chemical Company, Kingsport, TN (US)

(21) Appl. No.: 19/107,077

(22) PCT Filed: Aug. 29, 2023
(86) PCT No.: PCT/US2023/073061

§ 371 Date: Feb. 27, 2025

Related U.S. Application Data
(60) Provisional application No. 63/374,127, filed on Aug. 31, 2022.

(51) Int. Cl. C08B 3/20

(52) U.S. Cl. CPC C08B 3/20

(57) ABSTRACT

A cellulose ester and/or cellulose ester fiber is produced from at least two different raw materials that each have recycled content from one or more from a waste materials. The resulting cellulose ester and/or cellulose ester fiber has higher recycled content than if only one of the raw materials used to make it had recycled content.

### BACKGROUND

### 1. Field

The present application is generally related to the production of cellulose esters and cellulose ester fibers having recycled content.

### 2. Description of the Related Art

Dissolving-grade wood pulp raw materials are generally used to manufacture cellulosic fibers used in consumer textiles. While there are sustainably managed forests from which to obtain at least some of the required wood pulp supply, that is not ideal. Additionally, the global textiles industry generates substantial quantities of waste textiles that end up in landfills or incinerated each year. There is a need for technologies that reduce the use of wood pulp while simultaneously decreasing landfill contributions and polluting incineration processes.

### SUMMARY

In one embodiment, the present disclosure provides a process comprising reacting an esterification agent with cellulose to form a cellulose ester. At least a portion of the cellulose is derived from a first waste material and at least a portion of the esterification agent is derived from a second waste material. The resulting cellulose ester has recycled content from both the cellulose and the esterification agent used to make the cellulose ester.

In another embodiment, the disclosure provides a process for making recycled content cellulose ester fibers. The process comprises (a) providing a first raw material having recycled content derived from textile waste; (b) providing a second raw material having recycled content derived from waste plastic; (c) synthesizing a recycled content cellulose ester material from at least the first raw material and the second raw material, such that the recycled content cellulose ester material has recycled content derived from textile waste and waste plastic; and (d) spinning the recycled content cellulose ester material to produce recycled content cellulose ester fibers having recycled content derived from textile waste and waste plastic.

In still another embodiment, the disclosure provides a process for making recycled content cellulose ester fibers, where the process comprises (a) esterifying a recycled content cellulose with a recycled content esterification agent to thereby produce an initial cellulose ester material having recycled content from the recycled content cellulose and the recycled content esterification agent; (b) optionally, hydrolyzing the initial cellulose ester material to thereby produce a hydrolyzed cellulose ester material; and (c) spinning at least one of the initial cellulose ester material and the hydrolyzed cellulose ester material to thereby produce recycled content cellulose ester fibers having recycled content from the recycled content cellulose and the recycled content esterification agent.

In yet another embodiment, the disclosure provides a recycled content cellulose ester fiber formed from a cellulose ester material have repeating units of the following structure:

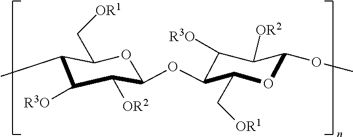

wherein the six membered rings are glucose rings and R1, R2, and R3 are selected independently from the group consisting of hydrogen or straight chain alkanoyls having from 2 to 10 carbon atoms. The DS_{acetyl} of the cellulose ester material is in the range of 1.5 to 2.95, 2.0 to 2.65, or 2.25 to 2.55. The DSOH of the cellulose ester material is in the range of 0.5 to 1.5, 0.3 to 1.4, or 2.25 to 2.55. At least a portion, at least 10 percent, at least 20, percent, at least 40 percent, at least 60 percent, at least 80 percent, at least 90 percent, or 100 percent of the alkanoyls are recycled content alkanoyls derived from waste plastic and at least a portion, at least 10 percent, at least 20, percent, at least 40 percent, at least 60 percent, at least 80 percent, at least 90 percent, or 100 percent of the glucose rings are recycled content glucose rings derived from textile waste.

In a further embodiment, the disclosure provides an article comprising the cellulose ester fiber having recycled content.

### DETAILED DESCRIPTION

The present application generally relates to a cellulose ester preparation process that produces a cellulose ester materials having recycled content from two or more of the raw materials used to make the cellulose ester. In one embodiment, the process utilizes pre-consumer textile waste as at least one of the raw materials used to make the recycled content cellulose ester. In one embodiment, the disclosed process comprises reacting an esterification agent with cellulose pulp derived from a pre-consumer textile waste to form a cellulose ester, where both the esterification agent and the cellulose pulp have recycled content derived from a waste material.

Pre-consumer textile waste may be waste generated by the commercial textile industry during the processing of cotton-based fibers, such as during garment, fabric, and/or yarn manufacturing. Pre-consumer textile waste may comprise any off-class material from any step in the manufacturing process: carding through to the final manufacturing steps of the particular process. Waste generated by the commercial textile industry during startup and/or shutdown of a manufacturing process and/or during transition to a new material. Pre-consumer textile waste can be differentiated from post-consumer textile waste in that latter includes garments that were fabricated and passed to, and/or used by, consumers. Pre-consumer textile waste may comprise, consist essentially of, or consist of one or more of cotton linters, undercard, fabric clippings, cattle feed waste, comber knolls, pneumafil waste, shoddy waste, yarn waste, production waste, cutter clippings, twisting waste, or mixtures thereof.

Cotton ginning leaves short cellulose fiber on the seed after staple cotton is removed by ginning or other separation methods. These fibers are referred to as cotton linters, and cotton linters are a pre-consumer textile waste that may be used as a dissolving pulp, as described in this disclosure.

In the cotton textile spinning process, short fibers, seed waste, and stems are removed before the spinning process. The opening and carding equipment used for this process has a filtration extraction system that removes and collects these particles. In the process of separating the good fiber from the external particles, some fiber is generally still captured. Undercard includes this fiber, and is a pre-consumer textile waste that may be used to prepare cellulose esters as described herein.

Each textile cutting operation has a pattern that is cut from a standardized width of fabric, leaving scraps of the fabric that does not become part of the final garment and would likely be discarded as waste. Many of these fabrics were originally formed from a cellulosic material. Fabric clippings such as these are a pre-consumer textile waste that may be used to prepare cellulose esters as described herein. T-shirt clippings are an example of a fabric clipping that would be suitable for use as a pre-consumer textile waste.

Cattle feed waste includes heavy seed and stem cotton trashier than undercard. Comber knolls includes good cotton but with short fibers of ½ inch (1.27 cm) or shorter. Pneumafil waste comprises fiber collected at drawing or spinning during processing.

Shoddy waste comprises reprocessed fabric chopped into smaller pieces and torn back into fibers. Yarn waste comprises waste generated from off standard (e.g., not normal or usual) or cut packages. Twisting waste includes that captured at twisting for multiple ends and/or final package winding.

Production waste comprises material that is off standard (e.g., off shade, wrong weight fabric, broken needle runs, etc.). Cutter clippings comprise material from cut patterns that is not used to make garments.

In one embodiment, the pre-consumer textile waste may be in the form of a dissolving pulp. The dissolving pulp may be provided as a roll or a sheet, and that roll or sheet may contain cellulose from more than one source of pre-consumer textile waste and/or cellulose from a source(s) other than pre-consumer textile waste, such as bamboo, switchgrass, hemp, juice industry waste (such as that left over from the pulping process), sugar cane bagasse, or mixtures thereof.

In one embodiment or in combination with any other mentioned embodiments, at least 1%, at least 20%, at least 50%, at least 70%, at least 85%, at least 90%, or at least 100% by weight of the cellulose in the dissolving pulp will be from a pre-consumer textile waste source.

The roll or sheet of dissolving pulp may be mechanically conditioned prior to acetylation. Mechanical conditioning can include breaking the roll or sheet into smaller pieces (e.g., shredding, chopping). Additionally, multiple rolls or sheets of the same or different types (e.g., having celluloses from different sources, as described above) can be mechanically conditioned to form smaller pieces and combined with the smaller pieces obtained from the pre-consumer textile waste dissolving pulp.

In one embodiment or in combination with any other mentioned embodiments, the pre-consumer textile waste dissolving pulp will comprise not more than 3% by weight, not more than 2% by weight, not more than 1% by weight, not more than 0.5% by weight, not more than 0.1% by weight, or not more than 0% by weight surfactant molecules (charged or uncharged), based on the total weight of the pre-consumer textile waste dissolving pulp.

In one embodiment or in combination with any other mentioned embodiments, the pre-consumer textile waste dissolving pulp will comprise not more than 3% by weight, not more than 2% by weight, not more than 1% by weight, not more than 0.5% by weight, not more than 0.1% by weight, or not more than 0% by weight silicon atoms, based on the total weight of the pre-consumer textile waste dissolving pulp.

In one embodiment, the pre-consumer textile waste dissolving pulp will comprise not more than 3% by weight, not more than 2% by weight, not more than 1% by weight, not more than 0.5% by weight, not more than 0.1% by weight, or not more than 0% by weight silicon atoms and surfactant molecules combined, based on the total weight of the pre-consumer textile waste dissolving pulp.

In one embodiment or in combination with any other mentioned embodiments, the pre-consumer textile waste dissolving pulp will have one, two, three, four, five, six, seven, eight, nine, ten, eleven, or twelve of the properties of Table A, in any combination. In one embodiment or in combination with any other mentioned embodiments, the pre-consumer textile waste dissolving pulp will have all thirteen properties of Table A.

TABLE A

| Alpha Cellulose, | more than | more than | more than | more than |
|---|---|---|---|---|
| R10+ ½(S10-S18) | 90 | 94 | 96 | 99 |
| Non-cotton fiber in raw | less than | less than | less than | 0% |
| material feedstock | 3% | 2% | 1% | |
| (% by weight) | | | | |
| Cuene IV (dL/g) | 5 to 15 | 6 to 14 | 7 to 13 | 8 to 12 |
| ISO Brightness (%) | more than | more than | more than | more than |
| | 75 | 80 | 85 | 90 |
| Ash (%) | less than | less than | less than | less than |
| | 0.2% | 0.15% | 0.1% | 0.06% |
| Iron (ppm) | less than | less than | less than | less than |
| | 20 | 15 | 12 | 10 |
| Calcium (ppm) | less than | less than | less than | less than |
| | 40 | 35 | 32 | 30 |
| Sodium (ppm) | less than | less than | less than | less than |
| | 650 | 630 | 620 | 600 |
| Silicon (ppm) | less than | less than | less than | less than |
| | 65 | 60 | 55 | 50 |
| S10 (%) | less than | less than | less than | less than |
| | 5% | 4% | 3% | 2% |
| S18 (%) | less than | less than | less than | less than |
| | 3% | 2.5% | 2% | 1% |
| DCM Extractables | less than | less than | less than | less than |
| (% by weight) | 0.3% | 0.2% | 0.1% | 0.03% |
| Cellulose II content | less than | less than | less than | 0% |
| (% by weight) | 2% | 1.5% | 1% | |

Regardless of the pre-consumer textile waste source, the cellulose esters can be produced by any method known in the art. The dissolving pulp may be steeped, such as by dissolving the pulp in water, acetic acid and/or glacial acetic acid, so as to cause the fibers to swell, which may increase chemical reactivity. If mechanical conditioning is carried out, steeping may take place after that mechanical conditioning. In one embodiment, steeping can be carried out at a temperature of at least 15° C., at least 17° C., at least 20° C., at least 23° C., at least 25° C., at least 27° C., or at least 30° C., and/or not more than 65° C., not more than 63° C., not more than 60° C., not more than 57° C., not more than 55° C., not more than 53° C., or not more than 50° C. In one embodiment or in combination with any other mentioned embodiments, steeping may be carried out for 30 minutes to 90 minutes, or 50 minutes to 70 minutes. In embodiments where the pulp is dissolved in water, dewatering may be carried out prior to esterification.

Suitable esterification agents may include an acetylating agent, such as acetic anhydride. In one embodiment or in combination with any other mentioned embodiments, a catalyst (e.g., sulfuric acid), an organic acid (e.g., acetic acid), or both a catalyst and acetic acid will be present during acetylation.

As discussed above, at least a portion of the esterification agent can be derived from a waste material, so that the resulting cellulose ester has recycled content from the esterification agent, along with recycled content from a source of waste cellulose (e.g., textile waste). In one embodiment, at least a portion of the esterification agent is derived from recycled content synthesis gas. The recycled content synthesis can be made by carbon reforming (e.g., gasifying) one or more feedstocks comprising waste materials and/or having recycled content. Methods of providing recycled content synthesis gas are disclosed in U.S. Patent Application Publication No. US20220119987A1, the entire disclosure of which is incorporated herein by reference to the extent consistent with this disclosure. Other methods of providing recycled content synthesis gas are disclosed in U.S. Patent Application Publication No. 20200247910A1, the entire disclosure of which is incorporated herein by reference to the extent consistent with this disclosure. U.S. Patent Application Publication Nos. US20220119987A1 and 20200247910A1 are also included herewith as Appendix A and B, respectively.

In one embodiment or in combination with any other mentioned embodiments, the esterification agent has recycled content derived from waste plastic. The recycled content from waste plastic can be provide by, for example, (i) carbon reforming waste plastic to provide a syngas having recycled content from waste plastic or (ii) pyrolyzing waste plastic to produce a pyrolysis effluent having recycled content from waste plastic and then carbon reforming at least a portion of the pyrolysis effluent to provide a syngas having recycled content from waste plastic.

In one embodiment or in combination with any other mentioned embodiments, at least a portion of the recycled content syngas from the carbon reforming can be reacted in the presence of a catalyst to form recycled content methanol. The recycled content methanol can then be subjected to carbonylation to form recycled content acetic acid and/or recycled content acetic anhydride. All or a portion of the acetic acid/anhydride may be used as the esterification agent and/or in the esterification process.

In one embodiment or in combination with any other mentioned embodiments, acetylation can be carried out at a temperature of at least 5° C., at least 7° C., at least 10° C., at least 13° C., at least 15° C., at least 20° C., or at least 25° C., and/or not more than 95° C., not more than 93° C., not more than 90° C., not more than 85° C., not more than 80° C., not more than 75° C., or not more than 70° C. In one embodiment or in combination with any other mentioned embodiments, acetylation may be carried out for 10 minutes to 3 hours, or 15 minutes to 2 hours.

The foregoing process will yield a cellulose triester (e.g., cellulose triacetate). In embodiments where a secondary ester is desired (e.g., cellulose diacetate), the reaction solution can be subjected to a partial hydrolysis reaction, which will convert cellulose triacetate to cellulose diacetate. This process may comprise adding water to the triacetate solution and heating to at least 40° C., at least 45° C., at least 50° C., at least 55° C., at least 60° C., or at least 65° C., and/or not more than 100° C., not more than 95° C., not more than 90° C., not more than 85° C., not more than 80° C., or not more than 75° C. In one embodiment or in combination with any other mentioned embodiments, hydrolysis may be carried out for 4 hours to 25 hours, or 5 hours to 20 hours. In one embodiment, or in combination with any other mentioned embodiments, hydrolysis may be carried out in the presence of an acid catalyst (e.g., sulfuric acid).

Cellulose esters formed as described herein generally comprise repeating units of the structure:

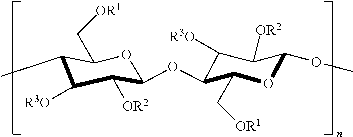

wherein R¹, R², and R³ are selected independently from the group consisting of hydrogen or straight chain alkanoyls having from 2 to 10 carbon atoms. Exemplary alkanoyls include acetyl, propionyl, and/or butyryl.

For cellulose esters, the substitution level is usually expressed in terms of degree of substitution (“DS”), which is the average number of non-OH substituents per anhydroglucose unit (“AGU”). Generally, conventional cellulose contains three hydroxyl groups in each AGU unit that can be substituted; therefore, DS can have a value between zero and three. However, low molecular weight cellulose esters can have a total degree of substitution slightly above 3 due to end group contributions. Because DS is a statistical mean value, a value of 1 does not assure that every AGU has a single substituent. In some cases, there can be unsubstituted AGU's, some with two and some with three substituents. The “Total DS” is defined as the average number of all of substituents per AGU and typically the value will be a non-integer. The degree of substitution per AGU can also refer to a particular substituent, such as, for example, hydroxyl, acetyl, butyryl, or propionyl.

In one embodiment or in combination with any other mentioned embodiments, the cellulose ester comprises a DS_{acetyl} of at least 1.5, at least 1.55, at least 1.6, at least 1.65, at least 1.7, at least 1.75, at least 1.8, at least 1.85, at least 1.9, at least 1.95, at least 2.0, at least 2.05, at least 2.1, at least 2.15, at least 2.2, at least 2.25, at least 2.3, at least 2.35, or at least 2.38 and/or not more than 2.95, not more than 2.9, not more than 2.8, not more than 2.7, not more than 2.6, not more than 2.55, not more than 2.5, or not more than 2.45. In certain embodiments, the cellulose ester may comprise a DS_{acetyl} in the range of 2.7 to 2.95, 1.5 to 2.6, 1.6 to 2.6, 1.7 to 2.6, 1.8 to 2.6, 1.9 to 2.6, 2.0 to 2.6, 2.05 to 2.6, 2.1 to 2.6, 2.15 to 2.6, 2.2 to 2.6, 2.25 to 2.55, 2.3 to 2.5, or 2.38 to 2.45.

Additionally or alternatively, in one embodiment or in combination with any other mentioned embodiments, the cellulose ester comprises a DS_{OH} of at least 0.05, at least 0.1, at least 0.2, at least 0.3, at least 0.4, or at least 0.5 and/or not more than 1.5, not more than 1.4, not more than 1.3. not more than 1.2, not more than 1.1, or not more than 1.0. In certain embodiments, the cellulose ester comprises a DS_{OH} in the range of 0.05 to 1.5, 0.1 to 1.5, 0.2 to 1.4, 0.3 to 1.2, 0.4 to 1.1, or 0.5 to 1.0.

Additionally or alternatively, in one embodiment or in combination with any other mentioned embodiments, the cellulose ester comprises a DS_{butyryl} of at least 0.1, at least 0.2, or at least 0.3 and/or not more than 1.5, not more than 1.4, not more than 1.3, not more than 1.2, not more than 1.1, not more than 1.0, not more than 0.9, not more than 0.8, not more than 0.7, not more than 0.6, not more than 0.5, or not more than 0.4. In certain embodiments, the cellulose ester comprises a DS_{butyryl} in the range of 0.1 to 1.5, 0.1 to 1.2, 0.1 to 0.8, 0.1 to 0.4, 0.2 to 1.5, 0.2 to 1.2, 0.2 to 0.8, 0.2 to 0.4, 0.3 to 1.5, 0.3 to 1.2, 0.3 to 0.8, or 0.3 to 0.6.

Additionally or alternatively, in one embodiment or in combination with any other mentioned embodiments, the cellulose ester comprises a DS_{propionyl} of at least 0.1, at least 0.2, or at least 0.3 and/or not more than 1.5, not more than 1.4, not more than 1.3, not more than 1.2, not more than 1.1, not more than 1.0, not more than 0.9, not more than 0.8, not more than 0.7, not more than 0.6, not more than 0.5, or not more than 0.4. In certain embodiments, the cellulose ester comprises a DS_{propionyl} in the range of 0.1 to 1.5, 0.1 to 1.2, 0.1 to 0.8, 0.1 to 0.4, 0.2 to 1.5, 0.2 to 1.2, 0.2 to 0.8, 0.2 to 0.4, 0.3 to 1.5, 0.3 to 1.2, 0.3 to 0.8, or 0.3 to 0.6.

Additionally or alternatively, in one embodiment or in combination with any other mentioned embodiments, the cellulose ester comprises a Total DS of at least 1.5, at least 1.55, at least 1.6, at least 1.65, at least 1.7, at least 1.75, at least 1.8, at least 1.85, at least 1.9, at least 1.95, at least 2.0, at least 2.05, at least 2.1, at least 2.15, at least 2.2, at least 2.25, at least 2.3, at least 2.35, or at least 2.38 and/or not more than 2.95, not more than 2.9, not more than 2.85, not more than 2.8, not more than 2.75, not more than 2.7, not more than 2.65, not more than 2.6, not more than 2.55, not more than 2.5, or not more than 2.45. In certain embodiments, the cellulose ester may comprise a Total DS in the range of 1.5 to 2.95, 1.6 to 2.85, 1.7 to 2.8, 1.8 to 2.75, 1.9 to 2.7, 2.0 to 2.65, 2.05 to 2.6, 2.1 to 2.6, 2.15 to 2.6, 2.2 to 2.6, 2.25 to 2.55, 2.3 to 2.5, or 2.38 to 2.45.

In one embodiment or in combination with any other mentioned embodiments, the cellulose ester can be a cellulose diacetate and/or cellulose triacetate. Alternatively, in certain embodiments, the cellulose ester can comprise a mixed cellulose ester, such as cellulose acetate butyrate or cellulose acetate propionate.

In one embodiment or in combination with any other mentioned embodiments, the cellulose ester can have a degree of acetylation of at least 30%, at least 35%, or at least 40% by weight and/or not more than 62.5%, not more than 60%, not more than 55%, not more than 50%, or not more than 45% by weight. In certain embodiments, the cellulose ester may have a degree of acetylation in the range of 30% to 62.55%, 35% to 55%, 35% to 50%, 35% to 45%, 40% to 62.55%, 40% to 60%, 40% to 55%, 40% to 50%, or 40% to 45% by weight.

Additionally or alternatively, in one embodiment or in combination with any other mentioned embodiments, the cellulose ester can have a hydroxyl content of at least 0.3%, at least 0.5%, at least 1%, at least 2%, at least 3%, or at least 4% by weight and/or not more than 20%, not more than 15%, not more than 10%, or not more than 5% by weight. In certain embodiments, the cellulose ester may have a hydroxyl content in the range of 0.3% to 20%, 0.5% to 20%, 2% to 15%, 3% to 10%, or 4% to 5% by weight.

In one embodiment or in combination with any other mentioned embodiments, the cellulose ester can have a number average degree of polymerization of at least 100, at least 110, at least 120, at least 130, at least 140, at least 150, at least 160, at least 170, at least 180, at least 190, at least 200, at least 210, at least 220, at least 230, at least 240, at least 250, at least 260, or at least 265. Additionally or alternatively, in one embodiment or in combination with any other mentioned embodiments, the cellulose ester can have a number average degree of polymerization of not more than 1,000, not more than 900, not more than 800, not more than 700, not more than 600, not more than 500, not more than 400, not more than 350, not more than 325, not more than 300, not more than 290, not more than 280, not more than 270, not more than 260, not more than 250, not more than 240, not more than 230, not more than 220, not more than 210, not more than 200, not more than 190, not more than 180, not more than 170, not more than 160, not more than 150, not more than 149, not more than 148, not more than 147, not more than 146, not more than 145, not more than 144, not more than 143, not more than 142, not more than 141, not more than 140, not more than 139, not more than 138, not more than 137, not more than 136, not more than 135, not more than 134, not more than 133, not more than 132, not more than 131, not more than 130, not more than 129, not more than 128, not more than 127, not more than 126, not more than 125, not more than 124, not more than 123, not more than 122, not more than 121, not more than 120, not more than 119, not more than 118, not more than 117, not more than 116, or not more than 115. In certain embodiments, the cellulose ester can have a number average degree of polymerization in the range of 100 to 1,000, 100 to 500, 100 to 400, 100 to 300, 100 to 250, 100 to 200, 100 to 150, 100 to 135, 100 to 200, 100 to 150, 100 to 135, 100 to 180, 100 to 150, 100 to 145, 100 to 140, 100 to 135, or 100 to 130.

In one embodiment or in combination with any other mentioned embodiments, the cellulose ester can comprise a number average absolute molecular weight of at least 5,000 Daltons, at least 10,000 Daltons, at least 15,000 Daltons, at least 20,000 Daltons, or at least 25,000 Daltons and/or not more than 75,000 Daltons, not more than 70,000 Daltons, not more than 65,000 Daltons, not more than 60,000 Daltons, not more than 55,000 Daltons, not more than 50,000 Daltons, not more than 45,000 Daltons, not more than 40,000 Daltons, not more than 35,000 Daltons, or not more than 30,000 Daltons as measured by gel permeation chromatography (“GPC”) according to ASTM D6474. In certain embodiments, the cellulose ester can comprise a number average absolute molecular weight in the range of 5,000 Daltons to 75,000 Daltons, 10,000 Daltons to 65,000 Daltons, or 15,000 Daltons to 35,000 Daltons as measured by GPC according to ASTM D6474.

In one embodiment or in combination with any other mentioned embodiments, the cellulose ester can comprise a weight-average absolute molecular weight of at least 50,000 Daltons, at least 55,000 Daltons, at least 60,000 Daltons, at least 65,000 Daltons, at least 70,000 Daltons, at least 75,000 Daltons, at least 80,000 Daltons, or at least 85,000 Daltons and/or not more than 150,000 Daltons, not more than 140,000 Daltons, not more than 130,000 Daltons, not more than 120,000 Daltons, not more than 110,000 Daltons, not more than 100,000 Daltons, or not more than 95,000 Daltons as measured by GPC according to ASTM D6474. In certain embodiments, the cellulose ester can comprise a weight-average absolute molecular weight in the range of 50,000 Daltons to 150,000 Daltons, 70,000 Daltons to 120,000 Daltons, or 80,000 Daltons to 95,000 Daltons as measured by GPC according to ASTM D6474.

In one embodiment or in combination with any other mentioned embodiments, the cellulose ester can comprise a crystallinity of at least 1%, at least 2%, at least 5%, at least 10%, at least 15%, or at least 20% as measured according to ASTM F2625. Additionally or alternatively, in one embodiment or in combination with any other mentioned embodiments, the cellulose ester can comprise a crystallinity of not more than 25%, not more than 20%, not more than 15%, not more than 10%, not more than 9%, not more than 8%, not more than 7%, not more than 6%, not more than 5%, not more than 4%, not more than 3%, not more than 2%, or not more than 1% as measured according to ASTM F2625. In certain embodiments, the cellulose ester can comprise a crystallinity of 1% to 99%, 1% to 50%, 1% to 30%, 1% to 20%, or 1% to 15% as measured according to ASTM F2625.

In one embodiment or in combination with any other mentioned embodiments, the cellulose ester can exhibit a glass transition temperature of at least 120° C., at least 125° C., at least 130° C., at least 135° C., at least 140° C., at least 145° C., at least 150° C., at least 155° C., at least 160° C., at least 165° C., at least 170° C., or at least 175° C. and/or not more than 250° C., not more than 245° C., not more than 240° C., not more than 235° C., not more than 230° C., not more than 225° C., not more than 220° C., not more than 215° C., not more than 210° C., not more than 205° C., not more than 200° C., not more than 195° C., not more than 190° C., or not more than 185° C.

In one embodiment or in combination with any other mentioned embodiments, the cellulose ester can comprise a hemicellulose content of at least 0.1%, at least 0.25%, at least 0.5%, at least 1%, at least 2%, at least 3%, at least 4%, at least 5%, at least 6%, or at least 7% by weight. Additionally or alternatively, in one embodiment or in combination with any other mentioned embodiments, the cellulose ester can comprise a hemicellulose content of not more than 10%, not more than 9%, not more than 8%, not more than 7%, not more than 6%, not more than 5%, not more than 4%, not more than 3%, not more than 2%, or not more than 1% by weight.

Regardless of whether cellulose triacetate or cellulose diacetate is the desired end product, the cellulose ester flakes may be precipitated from solution, washed, and dried.

In one embodiment or in combination with any other mentioned embodiments, at least 20%, at least 40%, at least 60%, at least 80%, or at least 100% by weight of the cellulose in the flakes may be from a pre-consumer textile waste source.

The cellulose ester may then be formed into a dope, by dissolution in a suitable solvent, for wet spinning or dry spinning through a spinneret into one or more spun fibers. In one embodiment, the cellulose ester (e.g., cellulose triacetate) may be subjected to melt spinning through a spinneret to form one or spun fibers.

In one embodiment, the cellulose ester (I) prepared from a pre-consumer waste textile as described above may be the only cellulose ester added to the dope or subjected to melt spinning. In another embodiment, the cellulose ester (I) may be mixed or blended with a different cellulose ester flakes (II) to form a blend of at least two different cellulose esters.

Alternatively to precipitation and dissolving in the wet or dry spinning embodiments, the cellulose ester may remain in acid-based solution (i.e., acid dope) and used directly in a downstream fiber wet or dry spinning process. In one embodiment, the acid dope may be derived from only pre-consumer textile waste. In another embodiment, acid dopes from one or more other cellulose sources may be blended with an acid dope derived from pre-consumer textile waste(s).

In one embodiment or in combination with any other mentioned embodiments, the different cellulose ester (II) is not formed from cellulose that was derived from a pre-consumer textile waste. The cellulose ester flakes (II) may be formed from a cellulosic material chosen from wood pulp and/or other plant-based cellulose sources. Examples of other plant-based cellulose sources may include bamboo, switchgrass, hemp, juice industry waste (such as that left over from the pulping process), sugar cane bagasse, agricultural residues, or mixtures thereof.

In one embodiment or in combination with any other mentioned embodiments, at least 20%, at least 40%, at least 60%, at least 80%, or at least 100% by weight of the cellulose in the combination of cellulose ester (I) and cellulose ester (II) may be from a pre-consumer textile waste source.

In one embodiment or in combination with any other mentioned embodiments, if the pre-consumer textile waste comprises cotton linters, then the blend of cellulose ester (I) and cellulose ester (II) comprises not more than 95%, not more than 90%, not more than 85%, not more than 80%, not more than 75%, not more than 70%, not more than 65%, or not more than 60% by weight of cellulose ester formed from cellulose derived from cotton linters, based on the total weight of the flake blend.

In one embodiment or in combination with any other mentioned embodiments, the cellulose ester may be added to a dope so that the dope comprises at least 5%, at least 8%, at least 10%, at least 12%, at least 15%, at least 18%, at least 20%, or at least 22% by weight cellulose ester, and/or not more than 35%, not more than 33%, not more than 30%, not more than 29%, not more than 25%, not more than 22%, or not more than 20% by weight cellulose ester, based on the total weight of the dope. In certain embodiments, the cellulose ester dope comprises 5% to 35%, 10% to 35%, 12% to 35%, 15% to 35%, or 25% to 35% by weight of cellulose ester, based on the total weight of the dope.

The dissolution solvent should be added in sufficient quantities so as to effectively dissolve the cellulose ester, thereby forming the cellulose ester dope. In one embodiment or in combination with any other mentioned embodiments, the cellulose ester dope can comprise at least 65%, at least 70%, at least 75%, at least 80%, at least 85%, at least 90%, or at least 95%, or 99% and/or not more than 99%, not more than 95%, not more than 90%, or not more than 85% by weight of one or more dissolution solvents, based on the total weight of the dope. In certain embodiments, the cellulose ester dope comprises 65% to 99%, 70% to 95%, 75% to 95%, 80% to 95%, or 90% to 99% by weight of one or more dissolution solvents, based on the total weight of the dope.

The dissolution solvent may be any solvent(s) in which the particular cellulose ester is readily soluble. Examples of suitable dissolution solvents for cellulose diacetate include those chosen from acetone, methylene chloride, alcohols (e.g., methanol, ethanol), tetrahydrofuran, dimethylformamide, dimethylacetamide, formamide, N-formylmorpholine, N-methyl-2-pyrrolidone, N-methylformamide, N-vinylacetamide, or N-vinylpyrrolidone, methyl ethyl ketone, cyclohexanone, diacetone alcohol, ethylene glycol diacetate, or mixtures thereof. Examples of suitable dissolution solvents for cellulose triacetate include those chosen from chloroform, methylene chloride, alcohols (e.g., methanol, ethanol), dimethylacetamide, dimethylformamide, formamide, N-formylmorpholine, N-methyl-2-pyrrolidone, N-methylformamide, N-vinylacetamide, or N-vinylpyrrolidone, or mixtures thereof.

The water or moisture content of the dope may be kept relatively low. In one embodiment or in combination with any other mentioned embodiments, the cellulose ester dope has a moisture content of not more than 4%, not more than 3.5%, not more than 3%, not more than 2.5%, not more than 2%, not more than 1.5%, not more than 1.4%, not more than 1.3%, not more than 1.2%, not more than 1.1%, not more than 1%, not more than 0.9%, not more than 0.8%, not more than 0.7%, or not more than 0.6% by weight, based on the total weight of the cellulose ester dope.

Due to the type of cellulose ester and dissolution solvents that are used, the cellulose dope may exhibit desirable operating viscosities. In one embodiment or in combination with any other mentioned embodiments, the cellulose ester dope may exhibit a viscosity of at least 10 poise, at least 20 poise, at least 30 poise, at least 40 poise, at least 50 poise, at least 60 poise, at least 70 poise, at least 80 poise, at least 90 poise, or at least 100 poise and/or not more than 3,000 poise, not more than 2,000 poise, not more than 1,500 poise, not more than 1,000 poise, not more than 950 poise, not more than 900 poise, not more than 850 poise, not more than 800 poise, not more than 750 poise, not more than 700 poise, not more than 650 poise, not more than 600 poise, not more than 550 poise, or not more than 500 poise when measured at the spinning temperature used for manufacturing the fiber. This spinning temperature is nominally the temperature of the dope as it passes through and into the spinneret. The viscosity defined herein is the “zero” shear viscosity obtained by extrapolating to a very low shear rate when viscosity is plotted versus shear rate, or alternately by using a Brookfield viscometer at low spindle RPM. Thus, the “when measured” threshold does not in any manner reflect the use or practice of the actual cellulose ester dope.

In one embodiment or in combination with any other mentioned embodiments, the cellulose ester dope may exhibit a viscosity of at least 10 poise, at least 20 poise, at least 30 poise, at least 40 poise, at least 50 poise, at least 60 poise, at least 70 poise, at least 80 poise, at least 90 poise, or at least 100 poise and/or not more than 5,000 poise, not more than 4,000 poise, not more than 3,000 poise, not more than 2,000 poise, not more than 1,500 poise, not more than 1,000 poise, not more than 950 poise, not more than 900 poise, not more than 850 poise, not more than 800 poise, not more than 750 poise, not more than 700 poise, not more than 650 poise, not more than 600 poise, not more than 550 poise, or not more than 500 poise when measured at 25° C., 50° C., 60° C., 70° C., 80° C., 90° C., 100° C., or 110° C. It should be noted that this “when measured” standard does not require the cellulose ester dope to be utilized only at this designated temperature; rather, this temperature standard simply provides a temperature threshold at which to measure the viscosity of the cellulose ester dope. Thus, the “when measured” threshold does not in any manner reflect the use or practice of the actual cellulose ester dope. The viscosity may be measured using a Brookfield viscometer at low spindle RPM.

In one embodiment or in combination with any other mentioned embodiments, the cellulose ester dope may comprise some or no additives in addition to the cellulose ester. Such additives can include, but are not limited to, plasticizers, antioxidants, thermal stabilizers, pro-oxidants, inorganics, pigments, colorants, or combinations thereof.

In one embodiment or in combination with any other mentioned embodiments, the dope comprises no more than 10%, no more than 5%, no more than 3%, no more than 2%, no more than 1%, or 0% by weight polymers that are not cellulose esters, based on the total solids in the dope.

In one embodiment or in combination with any other mentioned embodiments, the dope comprises no more than 10%, no more than 5%, no more than 3%, no more than 2%, no more than 1%, or 0% by weight additives, based on the total solids in the dope. Examples of such additives include metal oxides, delusterants, plasticizers, water, biodegrading-enhancing agents, and/or fiber lubricants. Depending on the embodiment, the dope comprises any one or more of the foregoing % by weight ranges when combining the total weight in the dope of one, two, three, four, five, or all of the metal oxides, delusterants, plasticizers, water, biodegrading-enhancing agents, and/or fiber lubricants.

In one embodiment or in combination with any other mentioned embodiments, the dope comprises no more than 10%, no more than 5%, no more than 3%, no more than 2%, no more than 1%, or 0% by weight of the combination of additives and polymers that are not cellulose esters, based on the total solids in the dope.

In one embodiment or in combination with any other mentioned embodiments, the dope is prepared by mixing the cellulose ester, solvent, and any other components at lower temperatures. In certain embodiments, this mixing is performed by mixing at a temperature of at least 45° C., at least 46° C., at least 47° C., at least 48° C., at least 49° C., at least 50° C., at least 51° C., at least 52° C., at least 53° C., at least 54° C., at least 55° C., at least 56° C., at least 57° C., at least 58° C., at least 59° C., or at least 60° C. and/or not more than 140° C., not more than 130° C., not more than 120° C., not more than 110° C., not more than 105° C., not more than 104° C., not more than 103° C., not more than 102° C., not more than 101° C., not more than 100° C., not more than 99° C., not more than 98° C., not more than 97° C., not more than 96° C., or not more than 95° C. In certain embodiments, this temperature is 45° C. to 140° C., 45° C. to 105° C., 47° C. to 103° C., or 50° C. to 100° C.

In one embodiment or in combination with any other mentioned embodiments, this mixing is carried out for at least 5 minutes, at least 6 minutes, at least 8 minutes, at least 10 minutes, at least 12 minutes, at least 14 minutes, or at least 15 minutes and/or not more than 48 hours, not more than 36 hours, not more than 24 hours, not more than 20 hours, not more than 16 hours, not more than 12 hours, or not more than 8 hours. In certain embodiments, this time is 5 minutes to 48 hours, 5 minutes to 36 hours, 5 minutes to 24 hours, or 5 minutes to 8 hours.

After forming the cellulose ester dope, it may be routed to an optional dope holding tank for temporary storage and/or deaeration. The dope holding tank can comprise any conventional storage tank known in the art that is capable of storing the cellulose ester dope. While stored in the holding tank, the cellulose ester dope may be subjected to conditions facilitated to maintain the physical characteristics of the dope and/or remove gas bubbles introduced during the mixing step. The temperature and pressure of the holding and/or deaeration tank may be optimized as necessary to enhance and maintain the quality of the cellulose ester dope.

Next, the cellulose ester dope can be pumped out of the dope holding tank into a filter, which may remove any large and undesirable particulates and gels from the cellulose ester dope prior to spinning. The filter can comprise any conventional filter apparatus and filter type known in the art. After filtering, the filtered cellulose ester dope may be pumped to a spinneret positioned near or in an evaporation chamber or cabinet for dry spinning, or near a coagulation bath for wet spinning.

The cellulose ester dope may be metered through the spinneret to thereby form one or more fibers. The shape and size of the hole or holes in the spinneret help determine the cross section of the fiber(s). The number of holes in the spinneret face determines the number of fibers simultaneously formed as dope is metered into the spinneret. As the dope passes through the holes in the spinneret face, the individual fibers form.

More particularly, in one embodiment or in combination with any other mentioned embodiments, the cellulose ester dope can be spun at a rate of 10 to 1000 m/min through spinneret holes having a design known in the art (e.g., having a hole area equivalent to a circular diameter of 20 to 200 microns). In one embodiment or in combination with any other mentioned embodiments, the spinneret may be maintained at a temperature of at least 50° C., at least 55° C., at least 60° C., at least 65° C., at least 70° C., or at least 75° C. and/or not more than 175° C., not more than 170° C., not more than 165° C., not more than 160° C., not more than 155° C., or not more than 150° C. In certain embodiments, the head of the spinneret may be maintained at a temperature in the range of 50° C. to 175° C., 75° C. to 175° C., 85° C. to 165° C., 95° C. to 160° C., or 100° C. to 150° C.

At the spinneret, the cellulose ester dope can be extruded through a plurality of holes to form continuous cellulose ester fibers. At the spinneret, fibers may be drawn to form bundles of multiple individual fibers, or hundreds of individual fibers, or even one thousand individual fibers. Each of these bundles may include at least 10, at least 20, at least 30, at least 40, at least 50, at least 60, at least 70, at least 80, at least 90, at least 100, at least 150, at least 200, at least 250, at least 300, at least 350, or at least 400 and/or not more than 1,000, not more than 900, not more than 800, not more than 700, or not more than 600 fibers. The spinneret may be operated at any speed suitable to produce individual filament fibers, which are then assembled into bundles having desired size and shape. As used herein, the term “individual filament fiber” refers to the continuous filament that is initially produced by each hole in the face of the spinneret.

For dry spinning, the fibers are extruded through the spinneret into a vertical spinning cabinet, which may have walls that are nominally 150° C. to 240° C. and which may contain gases inside the cabinet that are nominally 200-500° C., where the solvent is flashed off or evaporated. In certain embodiments, evaporating comprises exposing the spun fibers to temperatures of at least 100° C., at least 110° C., at least 120° C., at least 130° C., at least 140° C., at least 145° C., at least 150° C., at least 153° C., at least 155° C., at least 160° C., at least 165° C., at least 170° C., at least 175° C., at least 180° C., at least 185° C., or at least 189° C. and/or not more than 500° C. not more than 400° C., not more than 375° C., not more than 350° C., not more than 325° C., not more than 300° C., not more than 275° C., not more than 250° C., not more than 240° C., not more than 230° C., or not more than 220° C. In certain embodiments, this temperature is 100° C. to 500° C., 110° C. to 400° C., 120° C. to 375° C., 130° C. to 350° C., 140° C. to 300° C., or 150° C. to 250° C.

For wet spinning, the fibers may be drawn through a coagulation bath comprising a coagulation solvent formed from water or a blend of water and an additional solvent.

It should be noted that the cellulose ester fibers formed may be in the form of monocomponent fibers that are formed from only one material (e.g., the cellulose ester) or a uniformly blended composition and, therefore, would not be considered “bicomponent” or “multicomponent fibers,” which are characterized by internal phases or boundaries delineating different compositions within the external surface of the fiber. In one embodiment or in combination with any other mentioned embodiments, the resulting cellulose ester fibers can comprise at least 50%, at least 55%, at least 60%, at least 65%, at least 70%, at least 75%, at least 80%, at least 85%, at least 90%, at least 95%, at least 99%, or at least 99.9% by weight of the cellulose ester, based on the total weight of the fiber. In certain embodiments, the cellulose ester fiber can be formed entirely from the cellulose ester.

The individual cellulose ester fibers discharged from the spinneret, may have any suitable transverse cross-sectional shape. Exemplary cross-sectional shapes include, but are not limited to, round or other than round (non-round). In one embodiment or in combination with any other mentioned embodiments, the individual fibers discharged from the spinneret may have a substantially round cross-sectional shape. As used herein, the term “cross-section” generally refers to the transverse cross-section of the fiber measured in a direction perpendicular to the direction of elongation of the fiber. The cross-section of the fiber may be determined and measured using Quantitative Image Analysis (“QIA”).

The cross-sectional shape of an individual fiber may also be characterized according to its deviation from a round cross-sectional shape. In some cases, this deviation can be characterized by the shape factor of the fiber, which is determined by the following formula: Shape Factor=Perimeter/(4π×Cross-Sectional Area)^{1/2}. In some embodiments, the shape factor of the individual cellulose ester fibers can be from 1 to 2, 1 to 1.8, 1 to 1.7, 1 to 1.5, 1 to 1.4, 1 to 1.25, 1 to 1.15, or 1 to 1.1. The shape factor of a fiber having a perfect round cross-sectional shape is 1. The shape factor can be calculated from the cross-sectional area of the fiber, which can be measured using QIA.

Furthermore, in certain embodiments, the cellulose ester fibers may be in the form of solid fibers (fibers having a solid cross-sectional shape without an aperture present therein) and not in the form of hollow fibers.

In one embodiment or in combination with any other mentioned embodiments, at least 20%, at least 40%, at least 60%, at least 80%, or at least 100% by weight of the cellulose in the fibers may be from a pre-consumer textile waste source.

In one embodiment or in combination with any other mentioned embodiments, the cellulose ester fibers and/or the yarn produced therefrom may exhibit a tenacity of at least 0.2 g/denier, at least 0.3 g/denier, at least 0.4 g/denier, at least 0.5 g/denier, at least 0.6 g/denier, at least 0.7 g/denier, at least 0.8 g/denier, at least 0.9 g/denier, at least 1 g/denier, at least 1.1 g/denier, at least 1.2 g/denier, at least 1.3 g/denier, at least 1.4 g/denier, at least 1.5 g/denier, at least 1.6 g/denier, at least 1.7 g/denier, at least 1.8 g/denier, at least 1.9 g/denier, or at least 2 g/denier, and/or not more than 3.0, or not more than 2.5, not more than 2.3, not more than 2.1, not more than 2, or not more than 1.9 g/denier, as measured according to ASTM D22556.

Elongation, also known as elongation at break, is expressed as a percentage and it is indicative of how much a yarn or filament will stretch before it breaks. In one embodiment or in combination with any other mentioned embodiments, the cellulose ester fibers and/or the yarn produced therefrom may exhibit an elongation at break of at least 10%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, or at least 30% as measured according to ASTM D22556.

Silk factor (“SF”) is an empirically determined relationship between tenacity and elongation that is used to predict the failure envelope of a given fiber. Silk Factor can be used to characterize a yarn or fiber's suitability for use in a given process and is calculated based on the following formula:

$$Silk Factor = Tenacity * \sqrt{Elon g a t i o n}$$

In one embodiment or in combination with any other mentioned embodiments, the cellulose ester fibers and/or the yarn produced therefrom may exhibit a silk factor of at least 5.0, at least 6.0, at least 7.0, or at least 7.6, where elongation is defined as a percentage and tenacity is in grams/denier.

In one embodiment or in combination with any other mentioned embodiments, the cellulose ester fibers and/or the yarns formed therefrom can be biodegradable. As used herein, the term “biodegradable” generally refers to the tendency of a material to chemically decompose under certain environmental conditions. The degree of degradation can be characterized by the weight loss of a sample over a given period of exposure to certain environmental conditions. In some cases, the cellulose ester fibers and/or the yarns formed therefrom can exhibit a weight loss of at least 5%, at least 10%, at least 15%, or at least 20% after burial in soil for 60 days and/or a weight loss of at least 15%, at least 20%, at least 25%, at least 30%, or at least 35% after 15 days of exposure in a composter. However, the rate of degradation may vary depending on the particular end use of the fibers. Exemplary test conditions are provided in U.S. Pat. Nos. 5,870,988 and 6,571,802, incorporated herein by reference.

In one embodiment or in combination with any other mentioned embodiments, the cellulose ester fibers and/or the yarns formed therefrom can be compostable. To be considered “compostable,” a material must meet the following four criteria: (1) the material must be biodegradable; (2) the material must be disintegrable; (3) the material must not contain more than a maximum amount of heavy metals; and (4) the material must not be ecotoxic. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

In one embodiment or in combination with any other mentioned embodiments, the cellulose ester fibers and/or the yarns formed therefrom can be industrially compostable, home compostable, or both. In such embodiments, the cellulose ester fibers can satisfy four criteria: (1) biodegrade in that at least 90% carbon content is converted within 180 days; (2) disintegrable in that least 90% the material disintegrates within 12 weeks; (3) does not contain heavy metals beyond the thresholds established under the EN12423 standard; and (4) the disintegrated content supports future plant growth as humus; where each of these four conditions are tested per the ASTM D6400, ISO 17088, or EN 13432 method.

In one embodiment or in combination with any other mentioned embodiments, the cellulose ester fibers and/or the yarns formed therefrom can exhibit a biodegradation of at least 70 percent in a period of not more than 50 days, when tested under aerobic composting conditions at ambient temperature (28° C.±2° C.) according to ISO 14855-1(2012). In some cases, the cellulose ester fibers and/or the yarns formed therefrom can exhibit a biodegradation of at least 70 percent in a period of not more than 49, not more than 48, not more than 47, not more than 46, not more than 45, not more than 44, not more than 43, not more than 42, not more than 41, not more than 40, not more than 39, not more than 38, or not more than 37 days when tested under these conditions, also called “home composting conditions.” These conditions may not be aqueous or anaerobic.

In one embodiment or in combination with any other mentioned embodiments, the cellulose ester fibers and/or the yarns formed therefrom can exhibit a biodegradation of at least 60 percent in a period of not more than 45 days, when tested under aerobic composting conditions at a temperature of 58° C. (±2° C.) according to ISO 14855-1 (2012). In some cases, they can exhibit a biodegradation of at least 60 percent in a period of not more than 44 days when tested under these conditions, also called “industrial composting conditions.” These may not be aqueous or anaerobic conditions.

The newly-formed fibers may be accumulated onto cores or tubes at a winder after evaporation or solvent flash-off and may be sent to optional downstream processes. The fibers may be wrapped around a take-up roll, which provides tension and pulls the fibers into the downstream steps of the process, which may include, for example, one or more annealing sections, a winder, a crimper, a cutter, or a combination thereof.

The formed cellulose ester fibers may be gathered into a bundle, band, or yarn. The bundle, band, or yarn may comprise a plurality of the cellulose ester fibers. Each of these bundles, bands, or yarns may include at least 15, at least 20, at least 30, at least 40, at least 50, at least 60, at least 70, at least 80, at least 90, at least 100, at least 150, at least 200, at least 250, at least 300, at least 350, or at least 400 and/or not more than 70,000, not more than 60,000, not more than 50,000, not more than 40,000, not more than 30,000, not more than 20,000, not more than 15,000, not more than 10,000, not more than 5,000, not more than 1,000, not more than 900, not more than 800, not more than 700, or not more than 600 individual fibers.

In one embodiment or in combination with any other mentioned embodiments, the cellulose ester fibers and/or the cellulose ester bundle, band, or yarn may be passed through a crimping zone wherein a patterned wavelike shape may be imparted to at least a portion, or substantially all, of the individual fibers. When used, the crimping zone includes at least one crimping device for mechanically crimping the fibers. Generally, the cellulose ester fibers desirably are not crimped by thermal or chemical means (e.g., hot water baths, steam, air jets, or chemical coatings), but instead are mechanically crimped using a suitable crimper. One example of a suitable type of mechanical crimper is a “stuffing box” or “stuffer box” crimper that utilizes a plurality of rollers to generate friction, which causes the fibers to buckle and form crimps. Other types of crimpers may also be suitable. Examples of equipment suitable for imparting crimp fibers are described in, for example, U.S. Pat. Nos. 9,179,709; 2,346,258; 3,353,239; 3,571,870; 3,813,740; 4,004,330; 4,095,318; 5,025,538; 7,152,288; and 7,585,442, each of which is incorporated herein by reference to the extent not inconsistent with the present disclosure.

In one embodiment or in combination with any other mentioned embodiments, crimping may be performed such that the cellulose ester fibers have a crimp frequency of at least 5, at least 7, at least 10, at least 12, at least 13, at least 15, or at least 17 and/or up to 30, up to 27, up to 25, up to 23, up to 20, or up to 19 crimps per inch (“CPI”), as measured according to ASTM D3937-12. In certain embodiments, the average CPI of the fibers used to make the cellulose ester bundle, band, or yarns and/or various downstream products may be in the range of 7 to 30 CPI, 10 to 30 CPI, 10 to 27 CPI, 10 to 25 CPI, 10 to 23 CPI, 10 to 20 CPI, 12 to 30 CPI, 12 to 27 CPI, 12 to 25 CPI, 12 to 23 CPI, 12 to CPI, 15 to 30, CPI, 15 to 27 CPI, 15 to 23 CPI, 15 to 20 CPI, or 15 to 19 CPI.

In one embodiment or in combination with any other mentioned embodiments, when crimped, the crimp amplitude of the fibers may vary and can, for example, be at least 0.85, 0.90, 0.93, 0.96, 0.98, 1.00, or 1.04 mm. Additionally or alternatively, in one embodiment or in combination with any other mentioned embodiments, the crimp amplitude of the fibers can be up to 1.75, up to 1.70, up to 1.65, up to 1.55, up to 1.35, up to 1.28, up to 1.24, up to 1.15, up to 1.10, up to 1.03, or up to 0.98 mm.

Additionally, in one embodiment or in combination with any other mentioned embodiments, the cellulose ester fibers, the cellulose ester bundle, band, or yarn, and/or staple fibers produced therefrom may have a crimp ratio of at least 1:1. As used herein, “crimp ratio” refers to the ratio of the non-crimped tow length to the crimped tow length. In certain embodiments, the cellulose ester fibers, the cellulose ester yarns, and/or staple fibers produced therefrom may have a crimp ratio of at least 1:1, at least 1.1:1, at least 1.125:1, at least 1.15:1, or at least 1.2:1.

Crimp amplitude and crimp ratio are measured according to the procedure outlined in U.S. Pat. App. Pub. No. 2020/0299822, which is incorporated herein by reference to the extent not inconsistent with the present disclosure.

Additionally or alternatively, in one embodiment or in combination with any other mentioned embodiments, one or more types of surface finish may be applied to the cellulose ester fibers and/or the bundle, band, or yarn formed therefrom. The method of application is not limited and can include the use of spraying, wick application, dipping, or use of squeeze, lick, or kiss rollers. The location for applying a finish to a fiber can vary depending on the function of the finish. For example, the lubricant finish can be applied after spinning and before crimping, or before gathering the fibers into a bundle. Cutting lubricants and/or antistatic lubricants can be applied before or after crimping and prior to drying. Suitable amounts of all finishes (whether lubricant, cutting lubricant, antistatic electricity finish, or otherwise) on the cellulose ester fibers can be at least 0.01, at least 0.02, at least 0.05, at least 0.10, at least 0.15, at least 0.20, at least 0.25, at least 0.30, at least 0.35, at least 0.40, at least 0.45, at least 0.50, at least 0.55, or at least 0.60 percent finish-on-yarn (“FOY”) relative to the weight of the dried cellulose ester fiber. Additionally or alternatively, in one embodiment or in combination with any other mentioned embodiments, the cumulative amount of finish may be present in an amount of not more than 2.5, not more than 2.0, not more than 1.5, not more than 1.2, not more than 1.0, not more than 0.9, not more than 0.8, or not more than 0.7 percent FOY based on the total weight of the dried fiber. The amount of finish on the fibers as expressed by weight percent may be determined by solvent extraction. As used herein “FOY” or “finish on yarn” refers to the amount of finish on the fiber or yarn less any added water.

In one embodiment or in combination with any other mentioned embodiments, the cellulose ester fibers can include at least one plasticizer or, in the alternative, no plasticizer. The cellulose ester fibers may comprise less than 30, less than 12, less than 10, less than 9, less than 8, less than 7, less than 6, less than 5, less than 4, less than 3, less than 2, less than 1, less than 0.5 weight percent of at least one plasticizer, based on the total weight of the cellulose ester fiber. When present, the plasticizer may be incorporated into the fiber itself by spinning a dope containing a plasticizer, contained in a flake used to make the dope, and/or the plasticizer may be applied to the surface of the fiber or filament by any of the methods used to apply a finish. If desired, the plasticizer can be contained in the finish formulation.

The resulting cellulose ester fibers may be used to produce a vast array of intermediate fiber products, such as tow band, staple fibers, filaments, bundles, slivers, bobbins, rovings, yarns, and/or bales, and end products such as fabrics, textiles, woven articles (e.g., woven fabrics or textiles), nonwoven articles (e.g., nonwoven webs, fabrics, or textiles), knitted textiles, tobacco filters, and/or heat-not-burn tobacco products.

In one embodiment or in combination with any other mentioned embodiments, the cellulose ester fibers and/or the cellulose ester yarns described above may be cut into staple fibers. Any suitable type of cutting device may be used that is capable of cutting the fibers to a desired length without excessively damaging the fibers. Examples of cutting devices can include, but are not limited to, rotary cutters, guillotines, stretch breaking devices, reciprocating blades, or combinations thereof. Once cut, the cellulose ester staple fibers may be baled or otherwise bagged or packaged for subsequent transportation, storage, and/or use. In one embodiment or in combination with any other mentioned embodiments, the d50 length of the staple fibers may be at least 10, at least 20, at least 30, at least 40, or at least 50 mm and/or not more than 450, not more than 400, not more than 350, not more than 300, not more than 250, not more than 200, not more than 150, not more than 115, not more than 110, not more than 105, not more than 100, or not more than 95 mm.

Additionally or alternatively, in one embodiment or in combination with any other mentioned embodiments, the denier per filament (weight in g of 9000 m fiber length), or “DPF,” of the cellulose ester fibers (whether cellulose ester staple fibers or cellulose ester continuous fibers) may be within a range of 0.5 to less than 30, or 0.5 to less than 20. The particular method for measurement is not limited and include the ASTM 1577-07 method using the FAVIMAT vibroscope procedure if filaments can be obtained from which the staple fibers are cut, a microbalance weight measurement of a sample of known length, or a width analysis using any convenient optical microscopy or analyzer. The DPF can also be correlated to the maximum width of a fiber.

In one embodiment or in combination with any other mentioned embodiments, the staple fibers can be formed into a cellulose ester spun yarn. Spun yarns are continuous strands comprising short staple fibers which are mechanically entangled by a staple yarn spinning process. Staple yarn spinning processes can be, but are not limited to, ring spinning, open-end spinning, air jet spinning, compact spinning, siro spinning, vortex spinning, worsted spinning, semi-worsted spinning, woolen spinning, and wet spinning with flax.

In one embodiment or in combination with any other mentioned embodiments, the cellulose ester fibers may be formed into a nonwoven article, such as a nonwoven textile. Exemplary nonwoven articles can include wet-laid nonwoven articles, air-laid non-woven articles, carded articles, and/or dry-laid non-woven articles.

In one embodiment or in combination with any other mentioned embodiments, the cellulose ester yarns may be formed into a woven article, such as a woven textile. Woven textiles can be formed on a loom by interlacing at least two yarns, a warp yarn, and a weft yarn, wherein the warp yarn strands are oriented in parallel, and the weft yarns are interlaced at an angle to the orientation of the warp yarns in an alternating pattern over and under the warp yarns.

In one embodiment or in combination with any other mentioned embodiments, the cellulose ester yarns may be formed into a knitted article, such as a knitted textile. Such knitted textiles may be formed by interlocking loops of yarn.

In one embodiment or in combination with any other mentioned embodiments, the end products described herein, including the staple fibers, yarns, nonwoven articles, knitted articles, and the woven articles, may comprise, consist essentially of, or consist of the cellulose ester fibers. The end products described herein, including the staple fibers, yarns, nonwoven articles, knitted articles, and the woven articles, may comprise at least 0.25, at least 0.5, at least 0.75, at least 1, at least 2, at least 3, at least 4, at least 5, at least 6, at least 7, at least 8, at least 9, at least 10, at least 12, at least 15, at least 18, at least 20, at least 25, at least 30, at least 35, at least 40, at least 45, at least 50, at least 55, at least 60, at least 65, at least 70, at least 75, at least 80, at least 85, at least 90, at least 95, at least 99, or at least 99.9 weight percent of one or more cellulose ester fibers, based on the total weight of the article. Additionally or alternatively, in one embodiment or in combination with any other mentioned embodiments, the end products described herein, including the staple fibers, yarns, nonwoven articles, knitted articles, and the woven articles, may comprise not more than 99, not more than 95, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, not more than 9, not more than 8, not more than 7, not more than 6, or not more than 5 weight percent of one or more cellulose ester fibers, based on the total weight of the article. In certain embodiments, the end products may be formed entirely from the cellulose ester fibers or comprise in the range of 0.25 to 50, 1 to 99, 1 to 50, 50 to 99, 1 to 20, or 0.25 to 5 weight percent of one or more cellulose ester fibers, based on the total weight of the article.

In one embodiment or in combination with any other mentioned embodiments, the end products described herein may have one, two, three, or four of the properties of Table B, in any combination. In one embodiment or in combination with any other mentioned embodiments, the end products will have all five properties of Table B.

TABLE B*

| Average ΔE CMC of | less than | less than | less than | less than |
|---|---|---|---|---|
| ivory data point | 0.65 | 0.55% | 0.45% | 0.35 |
| Average ΔE CMC of | less than | less than | less than | less than |
| harvest gold data point | 1.25 | 1 | 0.8 | 0.5 |
| Average ΔE CMC of | less than | less than | less than | less than |
| black data point | 1 | 0.8 | 0.6 | 0.45 |
| Average ΔE CMC of | less than | less than | less than | less than |
| gray data point | 1.3 | 1.1 | 1 | 0.90 |
| Average ΔE CMC of | less than | less than | less than | Less than |
| all gray data points | 1 | 0.9 | 0.8 | 0.5 |

*Determined as described in Example 3.

Each of the documents of Table C are incorporated by reference in their entireties, to the degree that they do not contradict the statements made herein. Additionally, any one or more of the embodiments disclosed in any one or more of the documents of Table C may be used in combination with each other and/or in combination with one or more of the embodiments disclosed herein, to the extent such a combination doesn't contradict a statement made herein.

TABLE C

| Filing Date | Publication Number | Patent Number | Title |
|---|---|---|---|
| Feb. 4, 2019 | WO2020/1693255 | | GASIFICATION OF TIRES AND SOLID |
| | | | FOSSIL FUELS |
| Feb. 4, 2019 | WO2020/163259 | | CELLULOSE ESTER COMPOSITIONS |
| | | | DERIVED FROM POST-CONSUMER |
| | | | TIRE CONTENT SYNGAS |
| Feb. 4, 2019 | US2020-0248083 | | GASIFICATION OF POST-CONSUMER |
| | | | TIRES AND SOLID FOSSIL FUELS TO |
| | | | PRODUCE ORGANIC COMPOUNDS |
| Feb. 4, 2019 | US2020-0248084 | | GASIFICATION OF TIRES AND SOLID |
| | | | FOSSIL FUELS IN A PERMITTED |
| | | | GASIFIER |
| Feb. 4, 2019 | | U.S. PAT. NO. 11,370,983 | GASIFICATION OF PLASTICS AND |
| | | | SOLID FOSSIL FUELS |
| | US2022-0169933 | U.S. PAT. NO. 11,286,436 | FEED LOCATION FOR GASIFICATION |
| | | | OF PLASTICS AND SOLID FOSSIL |
| | | | FUELS |
| Feb. 4, 2019 | US2022-0213397 | U.S. PAT. NO. 11,312,914 | GASIFICATION OF PLASTICS AND |
| | | | SOLID FOSSIL FUELS TO PRODUCE |
| | | | ORGANIC COMPOUNDS |
| Feb. 4, 2019 | US2020-0247910 | | CELLULOSE ESTER COMPOSITIONS |
| | | | DERIVED FROM RECYCLED PLASTIC |
| | | | CONTENT SYNGAS |
| Mar. 26, 2019 | WO2020/205392 | | GASIFICATION OF SIZE REDUCED |
| | | | TEXTILES AND SOLID FOSSIL FUELS |
| Mar. 26, 2019 | WO2020/205410 | | GASIFICATION OF SIZE REDUCED |
| | | | TEXTILES AND SOLID FOSSIL FUELS |
| | | | TO PRODUCE ORGANIC COMPOUNDS |
| Mar. 26, 2019 | WO2020/205414 | | POLYMERS, CHEMICALS, AND |
| | | | ARTICLES OBTAINED FROM SIZE |
| | | | REDUCED TEXTILE DERIVED SYNGAS |
| Mar. 26, 2019 | US2022-0135893 | | GASIFICATION OF DENSIFIED |
| | | | TEXTILES AND SOLID FOSSIL FUELS |
| Mar. 26, 2019 | US2022-0177790 | | GASIFICATION OF DENSIFIED |
| | | | TEXTILES AND SOLID FOSSIL FUELS |
| | | | TO PRODUCE ORGANIC COMPOUNDS |
| Mar. 26, 2019 | US2022-0119987 | | POLYMERS, ARTICLES, AND |
| | | | CHEMICALS MADE FROM DENSIFIED |
| | | | TEXTILE DERIVED SYNGAS |
| Apr. 23, 2019 | US2022-0169931 | | GASIFICATION OF TORRIFIED |
| | | | TEXTILES AND SOLID FOSSIL FUELS |
| Mar. 26, 2019 | WO2020/205405 | | CAMPAIGNING GASIFICATION OF |
| | | | TEXTILES AND PLASTICS AND SOLID |
| | | | FOSSIL FUELS |
| Mar. 26, 2019 | WO2020/205396 | | CAMPAIGNING GASIFICATION OF |
| | | | TEXTILES AND PLASTICS AND SOLID |
| | | | FOSSIL FUELS TO PRODUCE |
| | | | ORGANIC COMPOUNDS |
| Mar. 26, 2019 | US2022-0162344 | | POLYMERS, CHEMICALS, AND |
| | | | ARTICLES OBTAINED FROM |
| | | | GASIFYING HIGH CONCENTRATIONS |
| | | | OF WASTE PLASTIC AND TEXTILES |

Additional advantages of the various embodiments will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments but is not necessarily included. Thus, the present disclosure encompasses a variety of combinations and/or integrations of the specific embodiments described herein.

### Claim Supporting Disclosure—First Embodiment

In a first embodiment of the present technology there is provided a process comprising reacting an esterification agent with cellulose to form a cellulose ester, wherein at least a portion of said cellulose is derived from a first waste material and at least a portion of said esterification agent is derived from a second waste material, wherein said cellulose ester has recycled content from said cellulose and said esterification agent.

The first embodiment described in the preceding paragraph can also include one or more of the additional aspects listed below. Each of the following additional aspects of the first embodiment can be standalone features or can be combined with one or more of the other additional aspects to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
wherein at least one of the first and second waste materials is textile waste.
wherein said first and second waste material are different types of materials.
wherein said first waste material is textile waste.
   wherein said textile waste is pre-consumer textile waste.
      wherein said second waste material is waste plastic.
wherein at least a portion of said cellulose is derived from a renewable material, wherein said cellulose ester comprises renewable content from said renewable material.
   wherein said renewable material is wood pulp.
   wherein said first waste material is textile waste and said second waste material is waste plastic.
wherein the total recycled content of said cellulose ester is at least 20 percent, at least 40 percent, at least 50 percent, or at least about 60 percent.
   wherein said cellulose ester comprises at least 10 percent, at least 20 percent, at least 30 percent, or at least about 40 percent recycled content derived from said first waste material and at least 5 percent, at least 10 percent, at least 15 percent, or at least about 20 percent recycled content derived from said second waste material.
wherein said first waste material is textile waste.
   wherein said textile waste is pre-consumer textile waste.
   wherein said second waste material is waste plastic.
wherein at least a portion of said cellulose is derived from a renewable material, wherein said cellulose ester comprises at least 10 percent, at least 20 percent, at least 30 percent, or about 40 percent renewable content.
   wherein said renewable material is wood pulp.
      wherein said first waste material is textile waste.
         wherein said textile waste is pre-consumer textile waste.
         wherein said second waste material is waste plastic.
wherein said first waste material is pre-consumer textile waste chosen from cotton linters, undercard, fabric clippings, cattle feed waste, comber knolls, pneumafil waste, shoddy waste, yarn waste, production waste, cutter clippings, twisting waste, or mixtures of two or more thereof.
   wherein said pre-consumer textile waste consists essentially of, or consists of, cotton linters, undercard, fabric clippings, cattle feed waste, comber knolls, pneumafil waste, shoddy waste, yarn waste, production waste, cutter clippings, twisting waste, or mixtures thereof.
further comprising, prior to said reacting, mechanically conditioning a dissolving pulp, wherein said dissolving pulp comprises said cellulose.
   wherein said dissolving pulp is in the form of a sheet or roll, and said mechanically conditioning comprises forming said sheet or roll into smaller pieces.
further comprising steeping a dissolving pulp in acetic acid and/or water prior to said reacting.
   wherein said steeping is carried out after said mechanically conditioning.
wherein said esterification agent comprises an acetylating agent.
   wherein said acetylating agent comprises acetic anhydride.
wherein said reacting is carried out in the presence of acetic acid, a catalyst, or both acetic acid and a catalyst.
wherein said cellulose ester comprises cellulose triacetate, and further comprising hydrolyzing said cellulose triacetate to form cellulose diacetate
further comprising forming said cellulose ester into cellulose ester flakes (I).
   further comprising mixing said cellulose ester flakes (I) with cellulose ester flakes (II) so as to form a flake blend, wherein said cellulose ester flakes (II) are not formed from cellulose derived from pre-consumer textile waste.
      wherein said cellulose ester flakes (II) are formed from a cellulosic material chosen from wood pulp, bamboo, switchgrass, hemp, juice industry waste, sugar cane bagasse, or mixtures thereof.
         wherein if said pre-consumer textile waste comprises cotton linters, said flake blend comprises not more than 95%, not more than 90%, not more than 85%, not more than 80%, not more than 75%, not more than 70%, not more than 65%, or not more than 60% by weight of cellulose ester formed from cellulose derived from cotton linters, based on the total weight of the flake blend.
further comprising spinning a cellulose ester dope comprising said cellulose ester through a spinneret to make one or more spun fibers.
   further comprising at least one of: evaporating solvent from said one or more spun fibers; or drawing said one or more fibers through a coagulation bath.
further comprising spinning a cellulose ester dope comprising said cellulose ester through a spinneret to make one or more spun fibers.
   further comprising at least one of: evaporating solvent from said one or more spun fibers; or drawing said one or more fibers through a coagulation bath.
wherein said cellulose ester comprises a number average degree of polymerization of at least 100, at least 110, at least 120, at least 130, at least 140, at least 150, at least 160, at least 170, at least 180, at least 190, at least 200, at least 210, at least 220, at least 230, at least 240, at least 250, at least 260, or at least 265.
wherein said cellulose ester comprises a number average degree of polymerization of not more than 1,000, not more than 900, not more than 800, not more than 700, not more than 600, not more than 500, not more than 400, not more than 350, not more than 325, not more than 300, not more than 290, not more than 280, not more than 270, not more than 260, not more than 250, not more than 240, not more than 230, not more than 220, not more than 210, not more than 200, not more than 190, not more than 180, not more than 170, not more than 160, not more than 150, not more than 149, not more than 148, not more than 147, not more than 146, not more than 145, not more than 144, not more than 143, not more than 142, not more than 141, not more than 140, not more than 139, not more than 138, not more than 137, not more than 136, not more than 135, not more than 134, not more than 133, not more than 132, not more than 131, not more than 130, not more than 129, not more than 128, not more than 127, not more than 126, not more than 125, not more than 124, not more than 123, not more than 122, not more than 121, not more than 120, not more than 119, not more than 118, not more than 117, not more than 116, or not more than 115.
wherein said cellulose ester comprises a DSacetyl of at least 1.5, at least 1.55, at least 1.6, at least 1.65, at least 1.7, at least 1.75, at least 1.8, at least 1.85, at least 1.9, at least 1.95, at least 2.0, at least 2.05, at least 2.1, at least 2.15, at least 2.2, at least 2.25, at least 2.3, at least 2.35, or at least 2.38 and/or not more than 2.95, not more than 2.9, not more than 2.8, not more than 2.7, not more than 2.6, not more than 2.55, not more than 2.5, or not more than 2.45.
wherein said cellulose ester comprises a DSOH of at least 0.05, at least 0.1, at least 0.2, at least 0.3, at least 0.4, or at least 0.5 and/or not more than 1.5, not more than 1.4, not more than 1.3. not more than 1.2, not more than 1.1, or not more than 1.0.
wherein said cellulose ester comprises an acetyl content of at least 30%, at least 35%, or at least 40% by weight and/or not more than 65%, not more than 60%, not more than 55%, not more than 50%, or not more than 45% by weight.
wherein said cellulose ester comprises a hydroxyl content of at least 0.3%, at least 0.5%, at least 1%, at least 2%, at least 3%, or at least 4% by weight and/or not more than 20%, not more than 15%, not more than 10%, or not more than 5% by weight.
wherein said cellulose ester comprises a hemicellulose content of not more than 10%, not more than 9%, not more than 8%, not more than 7%, not more than 6%, not more than 5%, not more than 4%, not more than 3%, not more than 2%, or not more than 1% by weight.
wherein said cellulose ester comprises a number average absolute molecular weight of at least 5,000, at least 10,000, at least 15,000, at least 20,000, or at least 25,000 and/or not more than 75,000, not more than 70,000, not more than 65,000, not more than 60,000, not more than 55,000, not more than 50,000, not more than 45,000, not more than 40,000, not more than 35,000, or not more than 30,000.
wherein said cellulose ester comprises a weight-average absolute molecular weight of at least 50,000, at least 55,000, at least 60,000, at least 65,000, at least 70,000, at least 75,000, at least 80,000, or at least 85,000 and/or not more than 150,000, not more than 140,000, not more than 130,000, not more than 120,000, not more than 110,000, not more than 100,000, or not more than 95,000.
wherein said cellulose ester exhibits a glass transition temperature of at least 120° C., at least 125° C., at least 130° C., at least 135° C., at least 140° C., at least 145° C., at least 150° C., at least 155° C., at least 160, at least 165° C., at least 170° C., or at least 175° C. and/or not more than 250° C., not more than 245° C., not more than 240° C., not more than 235° C., not more than 230° C., not more than 225° C., not more than 220° C., not more than 215° C., not more than 210° C., not more than 205° C., not more than 200° C., not more than 195° C., not more than 190° C., or not more than 185° C.
wherein said cellulose ester comprises cellulose diacetate and/or cellulose triacetate.
wherein said cellulose ester comprises a mixed cellulose ester.
wherein said cellulose ester comprises cellulose acetate propionate and/or cellulose acetate butyrate.
wherein said cellulose ester comprises a DS of propionyl and/or butyral of at least 0.1, at least 0.2, or at least 0.3 and/or not more than 1.5, not more than 1.4, not more than 1.3, not more than 1.2, not more than 1.1, not more than 1.0, not more than 0.9, not more than 0.8, not more than 0.7, not more than 0.6, not more than 0.5, or not more than 0.4.
wherein at least a portion of the recycled content of said cellulose ester is directly derived from one or more waste materials.
wherein at least a portion of the recycled content of said cellulose ester is indirectly derived from one or more waste materials.
wherein a portion of the recycled content of said cellulose ester is directly derived from one or more waste materials and a portion of the recycled content of the cellulose ester is indirectly derived from one or more waste materials.
An article comprising a cellulose ester fiber formed according to any of the above features. said article being chosen from tow band, staple fibers, filaments, bundles, slivers, bobbins, rovings, yarns, bales, fabrics, textiles, woven articles, nonwoven articles, knitted textiles, tobacco filters, and/or heat-not-burn tobacco products.
The article having one, two, three, or four of the following properties, in any combination

### Claim Supporting Disclosure—Second Embodiment

In a second embodiment of the present technology there is provided a process for making recycled content cellulose ester fibers, said process comprising: (a) providing a first raw material having recycled content derived from textile waste; (b) providing a second raw material having recycled content derived from waste plastic; (c) synthesizing a recycled content cellulose ester material from at least said first raw material and said second raw material, wherein said recycled content cellulose ester material has recycled content derived from textile waste and waste plastic; and (d) spinning said recycled content cellulose ester material to produce recycled content cellulose ester fibers having recycled content derived from textile waste and waste plastic.

The second embodiment described in the preceding paragraph can also include one or more of the additional aspects listed below. The each of the following additional aspects of the second embodiment can be standalone features or can be combined with one or more of the other additional aspects to the extent consistent.
wherein the total recycled content of said recycled content cellulose ester fibers is at least 20 percent, at least 40 percent, at least 50 percent, or at least about 60 percent.
   wherein said recycled content cellulose ester fibers comprise at least 10 percent, at least 20 percent, at least 30 percent, or at least about 40 percent recycled content derived from textile waste and at least 5 percent, at least 10 percent, at least 15 percent, or at least about 20 percent recycle content derived from waste plastic.
      wherein said recycled content cellulose ester fibers comprise at least 10 percent, at least 20 percent, at least 30 percent, or about 40 percent renewable content.
         wherein said renewable content is derived from wood pulp utilized in said synthesizing of step (c).
wherein the total recycled content of said recycled content cellulose ester fibers is in the range of 10 to 100 percent, 20 to 90 percent, 30 to 90 percent, 50 to 70 percent, or about 60 percent.
   wherein said recycled content cellulose ester fibers comprise in the range of 10 to 80 percent, 20 to 60 percent, 30 to 50 percent, or about 40 percent recycled content derived from textile waste and in the range of 5 to 40 percent, 10 to 30 percent, 15 to 25 percent, or about 20 percent recycle content derived from waste plastic.
      wherein said recycled content cellulose ester fibers comprise in the range of 10 to 80 percent, 20 to 60 percent, 30 to 50 percent, or about 40 percent renewable content.
         wherein said renewable content is derived from wood pulp utilized in said synthesizing of step (c).
wherein said textile waste is pre-consumer textile waste.
   wherein said pre-consumer textile waste comprises at least 90 weight percent, 94 weight percent, 96 weight percent, or 99 weight percent alpha cellulose.
   wherein said pre-consumer textile waste is chosen from cotton linters, undercard, fabric clippings, cattle feed waste, comber knolls, pneumafil waste, shoddy waste, yarn waste, production waste, cutter clippings, twisting waste, or mixtures of two or more thereof.
   wherein said waste plastic is post-consumer waste plastic.
further comprise providing a third raw material having renewable content, wherein said synthesizing of step (c) includes synthesizing said recycled content cellulose material from at least the first, second, and third raw materials.
   wherein said third raw material is wood pulp.
      wherein said first raw material is pre-consumer textile waste.
         wherein said second raw material is at least one of acetic acid and acetic anhydride.
wherein said first raw material comprises at least 90 weight percent, 94 weight percent, 96 weight percent, or 99 weight percent alpha cellulose, wherein said second raw material comprises at least one of acetic acid and acetic anhydride.
   wherein said first raw material comprises cotton linters, undercard, fabric clippings, cattle feed waste, comber knolls, pneumafil waste, shoddy waste, yarn waste, production waste, cutter clippings, twisting waste, or mixtures of two or more thereof.
      wherein said second raw material comprises acetic anhydride.
wherein said textile waste comprises cotton and said waste plastic comprises at least one of plastic packaging and carpet fibers.
wherein said providing of step (a) comprises obtaining cotton-containing waste from an industrial textile manufacturing process.
   wherein said cotton-containing waste comprises at least 90, at least 94, at least 96, or at least 99 weight percent alpha cellulose.
wherein said providing of step (b) comprises converting waste plastic into a recycled content synthesis gas comprising recycled content hydrogen and recycled content carbon monoxide.
   wherein said providing of step (b) further comprises converting at least a portion of said recycled content synthesis gas into one or both of recycled content acetic anhydride and recycled content acetic anhydride.
      wherein said providing of step (b) comprises gasifying waste plastic to produce said recycled content synthesis gas.
      wherein said providing of step (b) comprises pyrolyzing waste plastic to produce a recycle content pyrolysis effluent and then gasifying at least a portion of said recycle content pyrolysis effluent to produce said recycled content synthesis gas.
      wherein said converting includes producing recycled content methanol from said recycled content synthesis gas and producing at least one of recycled content acetic acid and recycled content acetic anhydride from said recycled content methanol.
wherein said synthesizing of step (c) includes acetylating cellulose in acetic acid with acetic anhydride in the presence of a sulfuric acid catalyst.
   wherein at least a portion of said cellulose is from said first raw material and at least a portion of said acetic acid and/or acetic anhydride is from said second raw material.
   wherein at least 5, at least 10 weight percent, at least 20 weight percent, at least 40 weight percent, at least 60 weight percent, at least 80 weight percent, at least 90 weight percent, or 100 weight percent of said cellulose is from said first raw material, and wherein at least 5 weight percent, at least 10 weight percent, at least 20 weight percent, at least 40 weight percent, at least 60 weight percent, at least 80 weight percent, at least 90 weight percent, or 100 weight percent of said acetic anhydride is from said second raw material.
      wherein at least 5 weight percent, at least 10 weight percent, at least 20 weight percent, at least 40 weight percent, at least 60 weight percent, at least 80 weight percent, at least 90 weight percent, or 100 weight percent of said acetic acid is from said second raw material.
   wherein said synthesizing of step (c) further comprises hydrolyzing an intermediate cellulose ester product of said acetylating to thereby produce said recycled content cellulose ester.

### Claim Supporting Disclosure—Third Embodiment

In a third embodiment of the present technology there is provided a process for making recycled content cellulose ester fibers, said process comprising: (a) esterifying a recycled content cellulose with a recycled content esterification agent to thereby produce an initial cellulose ester material having recycled content from said recycled content cellulose and said recycled content esterification agent; (b) optionally, hydrolyzing said initial cellulose ester material to thereby produce a hydrolyzed cellulose ester material; and (c) spinning at least one of said initial cellulose ester material and said hydrolyzed cellulose ester material to thereby produce recycled content cellulose ester fibers having recycled content from said recycled content cellulose and said recycled content esterification agent.

The third embodiment described in the preceding paragraph can also include one or more of the additional aspects listed below. The each of the following additional aspects of the third embodiment can be standalone features or can be combined with one or more of the other additional aspects to the extent consistent.
wherein said recycled content esterification agent has recycled content derived from waste plastic.
wherein said recycle content cellulose comprises textile waste.
   wherein said textile waste is pre-consumer textile waste.
      wherein said pre-consumer textile waste is chosen from cotton linters, undercard, fabric clippings, cattle feed waste, comber knolls, pneumafil waste, shoddy waste, yarn waste, production waste, cutter clippings, twisting waste, or mixtures of two or more thereof.
      wherein said recycled content esterification agent has recycled content derived from post-consumer waste plastic.
wherein said recycled content esterification agent comprises one or both of acetic acid and acetic anhydride.
wherein said recycled content esterification agent comprises a recycled content acetylating agent.
   wherein said recycled content acetylating agent comprises recycled content acetic anhydride.
wherein said esterifying of step (a) includes esterifying a non-recycled content cellulose with said recycled content esterification agent to thereby produce said initial cellulose ester material.
   wherein said non-recycled content cellulose is a renewable cellulose.
      wherein said renewable cellulose comprises wood pulp.
wherein said esterifying is carried out in the presence of acetic acid and acetic anhydride.
   wherein said acetic acid and said acetic anhydride each comprise recycled content derived from a common waste material.
      wherein said common waste material is waste plastic.
wherein said esterifying is carried out in the presence of a sulfuric acid catalyst.
further comprising chemically recycling waste plastic to thereby produced the recycled content esterification agent.

### Claim Supporting Disclosure—Fourth Embodiment

In a fourth embodiment of the present technology there is provided a recycled content cellulose ester fiber formed from a cellulose ester material have repeating units of the following structure:

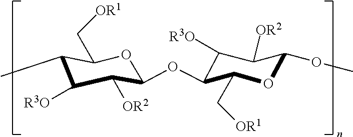

wherein the six membered rings are glucose rings, wherein R1, R2, and R3 are selected independently from the group consisting of hydrogen or straight chain alkanoyls having from 2 to 10 carbon atoms, wherein the DS_{acetyl} of said cellulose ester material is in the range of 1.5 to 2.95, 2.0 to 2.65, or 2.25 to 2.55, wherein the DS_{OH} of said cellulose ester material is in the range of 0.5 to 1.5, 0.3 to 1.4, or 2.25 to 2.55, wherein at least a portion, at least 10 percent, at least 20, percent, at least 40 percent, at least 60 percent, at least 80 percent, at least 90 percent, or 100 percent of said alkanoyls are recycled content alkanoyls derived from waste plastic, wherein at least a portion, at least 10 percent, at least 20, percent, at least 40 percent, at least 60 percent, at least 80 percent, at least 90 percent, or 100 percent of said glucose rings are recycled content glucose rings derived from textile waste.

The fourth embodiment described in the preceding paragraph can also include one or more of the additional aspects listed below. The each of the following additional aspects of the second embodiment can be standalone features or can be combined with one or more of the other additional aspects to the extent consistent.
wherein at least a portion of said glucose rings are non-recycled content glucose rings.
   wherein the ratio of non-recycled content glucose rings to recycled content glucose rings is in the range of 0.1:1 to 10:1, 0.5:1 to 5:1, 1:1 to 4:1, 1.5:1 to 3:1, or about 2:1.
   wherein said non-recycled content glucose rings are derived from a renewable material.
      wherein said renewable material is wood pulp.
wherein the total recycled content of said recycled content cellulose ester fiber is at least 20 percent, at least 40 percent, at least 50 percent, or at least about 60 percent.
   wherein said recycled content cellulose ester fiber comprises at least 10 percent, at least 20 percent, at least 30 percent, or at least about 40 percent recycled content derived from textile waste and at least 5 percent, at least 10 percent, at least 15 percent, or at least about 20 percent recycle content derived from waste plastic.
      wherein said recycled content cellulose ester fibers comprise at least 10 percent, at least 20 percent, at least 30 percent, or about 40 percent renewable content.
         wherein said renewable content is derived from wood pulp utilized in said synthesizing of step (c).
wherein the total recycled content of said recycled content cellulose ester fiber is in the range of 10 to 100 percent, 20 to 90 percent, 30 to 90 percent, 50 to 70 percent, or about 60 percent.
   wherein said recycled content cellulose ester fiber comprises in the range of 10 to 80 percent, 20 to 60 percent, 30 to 50 percent, or about 40 percent recycled content derived from textile waste and in the range of 5 to 40 percent, 10 to 30 percent, 15 to 25 percent or about 20 percent recycled content derived from waste plastic.
      wherein recycled content cellulose ester fiber comprises in the range of 10 to 80 percent, 20 to 60 percent, 30 to 50 percent, or about 40 percent renewable content.
         wherein said renewable content is derived from wood pulp.
wherein said textile waste is pre-consumer textile waste.
   wherein said pre-consumer textile waste comprises at least 90 weight percent, at least 94 weight percent, at least 96 weight percent, or at least 99 weight percent alpha cellulose.
   wherein said pre-consumer textile waste is chosen from cotton linters, undercard, fabric clippings, cattle feed waste, comber knolls, pneumafil waste, shoddy waste, yarn waste, production waste, cutter clippings, twisting waste, or mixtures of two or more thereof.
   wherein the waste plastic is post-consumer waste plastic.
wherein the total degree of substitution (DS) of said recycled content cellulose ester fiber is in the range of 1.5 to 2.95, 2.0 to 2.65, or 2.25 to 2.55.
wherein said recycled content cellulose ester fiber has a denier per filament (dpf) in the range of 0.5 to 30.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” “comprise,” “contain,” “containing,” and “contains” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

As used herein, the phrase “at least a portion” includes at least a portion and up to and including the entire amount or time period.

As used herein, the term “chemical pathway” refers to the chemical processing step or steps (e.g., chemical reactions, physical separations, etc.) between an input material and a product material, where the input material is used to make the product material.

As used herein, the term “chemical recycling” refers to a waste plastic recycling process that includes a step of chemically converting waste plastic polymers into lower molecular weight polymers, oligomers, monomers, and/or non-polymeric molecules (e.g., hydrogen, carbon monoxide, methane, ethane, propane, ethylene, and CO) that are useful by themselves and/or are useful as feedstocks to another chemical production process(es).

As used herein, the term “co-located” refers to the characteristic of at least two objects being situated on a common physical site, and/or within 5, 1, 0.5, or 0.25 miles of each other.

As used herein, the terms “credit-based recycled content,” “non-physical recycled content,” and “indirect recycled content” all refer to matter that is not physically traceable back to a waste material, but to which a recycled content credit has been attributed.

As used herein, the term “directly derived” refers to having at least one physical component originating from waste material.

As used herein, the term “indirectly derived” refers to having an applied recycled content (i) that is attributable to waste material, but (ii) that is not based on having a physical component originating from waste material.

As used herein, the term “located remotely” refers to a distance of at least 0.1, 0.5, 1, 5, 10, 50, 100, 500, or 1000 miles between two facilities, sites, or reactors.

As used herein, the term “mass balance” refers to a method of tracking recycled content based on the mass of the recycled content in various materials.

As used herein, the terms “physical recycled content” and “direct recycled content” both refer to matter that is physically traceable back to a waste material.

As used herein, the term “pre-consumer textile waste” refers to waste generated by the commercial textile industry during the processing of cotton-based fibers, such as during garment, fabric, and/or yarn manufacturing.

As used herein, the term “predominantly” means more than 50 percent by weight. For example, a predominantly propane stream, composition, feedstock, or product is a stream, composition, feedstock, or product that contains more than 50 weight percent propane.

As used herein, the term “recycled content” refers to being or comprising a composition that is directly and/or indirectly derived from recycle material. Recycled content is used generically to refer to both physical recycled content and credit-based recycled content. Recycled content is also used as an adjective to describe material having physical recycled content and/or credit-based recycled content.

As used herein, the term “recycled content credit” refers to a non-physical measure of physical recycled content that can be directly or indirectly (i.e., via a digital inventory) attributed from a first material having physical recycled content to a second material having less than 100 percent physical recycled content.

As used herein, the term “textile waste” refers to used, scrap, and/or discarded cotton-based materials from any source associated with the manufacture, sale, use, or disposal of textiles.

As used herein, the term “total recycled content” refers to the cumulative amount of physical recycled content and credit-based recycled content from all sources.

As used herein, the term “waste material” refers to used, scrap, and/or discarded material.

As used herein, the terms “waste plastic” and “plastic waste” refer to used, scrap, and/or discarded plastic materials.

numerical RANGES

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

Additionally, it should be understood that a listing of numerical values following a descriptor, such as “at least” and “not more than,” provides literal support for a range based on all of the numerical values following that descriptor. For example, a statement specifying “at least 2, 5, or 10 and/or not more than 100, 50, or 25” would provide literal support for ranges of “at least 25,” “not more than 50,” and “at least 10 and not more than 25.”

### EXAMPLES

The following examples set forth methods in accordance with the disclosure. It is to be understood, however, that these examples are provided by way of illustration, and nothing therein should be taken as a limitation upon the overall scope.

### Example 1

### Flake Preparation and Characterization

### 1. Flake Preparation

A pulp roll comprising cotton linters as the pre-consumer textile waste was shredded, and the shreds were steeped in glacial acetic acid. After steeping, the cellulose present in the shreds was acetylated with acetic anhydride followed by partial hydrolysis in the presence of sulfuric acid. Cellulose diacetate flakes were recovered from solution, washed, and dried. This process was repeated three times to generate four cellulose diacetate samples whose cellulose was derived entirely from cotton linters.

### 2. Acetyl Content and Intrinsic Viscosity of Flakes

The samples were analyzed for acetyl content and intrinsic viscosity (“IV”) and compared to a control, which was cellulose diacetate made by the same process except using 100% wood pulp.

To determine acetyl content, each flake sample was dissolved in acetone by stirring. After dissolution, the sample solution was injected into a liquid chromatography system, where the polymer was separated by reversed-phase liquid chromatography based on the degree of substitution. An evaporative light scattering detector was used for quantification. The calculations used are as follows:
Percent Acetyl

$$\begin{matrix}Wt \% Acetyl = m \times CT + b \\ Where : \\ Wt \% Acetyl = Weight percent acetyl \\ m = calibration slope in units of wt \% acetyl min - 1 \\ CT = peak centroid time of polymer sample in minutes \\ b = y - intercept of calibration line in units of wt \% acetyl\end{matrix}$$

Relative Acetyl Spread

$$\begin{matrix}\begin{matrix}R A S = \frac{WDs}{WDc} \\ Where :\end{matrix} \\ RAS = relative acetyl spread \\ WDs = Width in time of the sample peak at one - tenth height \\ WDc = Width in time of the control sample peak at one - tenth height\end{matrix}$$

Intrinsic viscosity was determined by first drying the flakes by heating in an MF-50 moisture analyzer for about 5 minutes at 130° C., followed by heating in a 105° C. oven for 30 minutes. The dried flakes were dissolved in acetone at a concentration of 0.75 g/dL. The samples were individually injected into a relative viscometer in which one capillary measured the pressure of the HPLC grade acetone, and the other capillary measured the pressure of the cellulose acetate and acetone sample solution. The ratio of the values was used to determine the relative viscosity. The calculations were:

$${η}_{rel} = \frac{{η}_{2} ( sample )}{{η}_{1} ( solvent )}$$

(Viscosity Relative to Solvent)

$${η}_{s p} = {η}_{2 rel} - 1$$

(specific viscosity)

$$[ η ] = \frac{{[ 2 ( {η}_{s p} - ln {η}_{rel} ]}^{0.5}}{c}$$

(Solomon-Gatesman Equation for Intrinsic viscosity)

In the above formula, “c” is the viscometer constant defined by the ratio of the two capillaries at base line conditions where the system has solvent flowing in both capillaries at stable pressures.

Table 1 sets forth these results.

TABLE 1

| Sample | | | |
|---|---|---|---|
| Identifier | Sample Content | %-Acetyl | IV (dL/g) |
| 1 | 100% Wood Pulp | 40.12 | 1.51 |
| 2 | 100% Cotton Linter Pulp | 40.09 | 2.08 |
| 3 | 100% Cotton Linter Pulp | 39.33 | 1.84 |
| 4 | 100% Cotton Linter Pulp | 39.79 | 1.58 |
| 5 | 100% Cotton Linter Pulp | 40.12 | 1.74 |
| 6 | Average of Samples #2-5 | 39.83 | 1.81 |
| 7 | Average of Samples #2-5 | 40.24 | 1.57 |
| | (after drying)^{A} | | |
| 8 | Mixture (after drying) of | 39.60 | 1.68 |
| | Equal Parts of Samples #2-5 | | |

^{A}Drying in a rotary cone vacuum dryer at 82° C. until moisture was below 2%.

A blend of 67% by weight Sample #1 flakes (100% wood pulp) and 33% by weight Sample #8 flakes (100% cotton linters) was prepared and analyzed for the acetyl content and intrinsic viscosity. Those results are in Table 2.

TABLE 2

| Sample | %-Acetyl | IV (dL/g) |
|---|---|---|
| Sample #8 Remeasure (100% CLP) | 39.63 | 1.69 |
| Sample #9 (Blend - 67% #1:33% #8) | 39.88 | 1.72 |

The foregoing shows that using a combination of flakes made from recycled cellulosic material with those made from traditional wood pulp resulted in substantially similar flake properties when compared to flakes made entirely from wood pulp and/or flakes made entirely from cotton linter pulp.

### 3. Polymer Evaluation

The respective molecular weights and polydispersity indices (“PDIs”) of the cellulose diacetates of Samples 2-5 and 8 were determined. Molecular weight was determined by GPC according to ASTM D6474. The molecular weight measurements were used to calculate PDI, which is defined as Mw/Mn. Table 3 gives those results.

TABLE 3

| | Sample #2 | Sample #3 | Sample #4 | Sample #5 | Sample #8 |
|---|---|---|---|---|---|
| Mn | 50989 | 45535 | 48923 | 44644 | 43637 |
| Mw | 134078 | 114945 | 118888 | 116502 | 107451 |
| Mz | 259703 | 216704 | 225080 | 223292 | 202944 |
| PDI | 2.63 | 2.52 | 2.43 | 2.61 | 2.46 |

### Example 2

### Yarn Preparation and Characterization

### 1. Yarn Preparation

Flake Samples 1 (100% wood pulp), 8 (100% cotton linters), and 9 (Blend) from Example 1 were individually dry spun into yarns following the procedure described previously.

### 2. Polymer Evaluation

The respective molecular weights and PDIs of the cellulose diacetates of the yarns formed from Samples 1, 8, and 9 were determined as described in Example 1. Table 4 gives those results.

TABLE 4

| | Sample #1 | Sample #8 | Sample #9 |
|---|---|---|---|
| | Yarn | Yarn | Yarn |
| Mn | 27547 | 28528 | 31551 |
| Mw | 95987 | 95035 | 90681 |
| Mz | 271412 | 258648 | 184139 |
| PDI | 3.48 | 3.33 | 2.87 |

### 3. Chip Whiteness

Yarns of Samples 1, 8, and 9 were analyzed for chip whiteness. A pressed chip was prepared from scoured, dried, ground, and pressed acetate fiber. The sample chip was presented and measured using a spectrophotometer at a wavelength range of 380-700 nm. Whiteness results were generated using the whiteness index based on the CIE Ganz 82 formula.

These results are shown in Table 5.

TABLE 5

| Sample | Chip Whiteness |
|---|---|
| Sample #1 Yarn | 79.3 |
| Sample #8 Yarn | 82.9 |
| Sample #9 Yarn | 83.3 |

Chip whiteness should be 73 or greater, showing that using recycled content as a cellulose source did not negatively affect the yarn.

### 4. Tensile Strength

Yarns of Samples 1, 8, and 9 were analyzed for tensile strength and elongation as described in ASTM D22556. These results are shown in Table 6.

TABLE 6

| | Elongation at | Tenacity |
|---|---|---|
| Sample | Break (%) | (gf/denier) |
| Sample #1 Yarn | 18.5 | 1.25 |
| Sample #8 Yarn | 19.5 | 1.25 |
| Sample #9 Yarn | 19.9 | 1.28 |

### Example 3

### Fabric Preparation and Dye Uptake Analysis

### 1. Fabric Preparation

Yarns from Samples 1 (100% wood pulp), 8 (100% cotton linters), and 9 (Blend) as described in Example 2 were individually knitted into a 100-GSM (±10) single knit jersey using a 9″ diameter 28 gg Vanguard Knitting Machine. The knitted fabrics were heat set in preparation for wet processing. Each pair of specimens that was being compared moved through the wet processing sequence together in the same dyeing vessel. Thus, the two specimens being compared experienced identical knitting, heat setting, and wet processing conditions. To identify whether any wet processing differences existed when the depth of shade was varied, four colors were dyed: ivory, harvest gold, gray, and black. The dyed fabrics were dried and conditioned for dye uptake analysis.

### 2. Fabric Color Comparison

The paired specimens from each dyeing vessel were measured against each other with the control specimen serving as the standard and the experimental specimen serving as the batch. Both the control specimen and the experimental specimen were folded to yield eight layers so that no light was transmitted through the fabric. The color coordinates ΔL, Δa, Δb, and ΔE CMC were recorded for each measurement. ΔL is a measure of lightness difference, Δa is a measure of red/green difference, and Δb is a measure of yellow/blue difference. The ΔE CMC is the total color difference between the two samples measured. This process was repeated with the fabric folded in a different manner, still yielding eight layers, to account for any differences that would result from the fabric being oriented differently.

This process was used to compare the shade impact of using different pulp sources. The three different comparisons were: 100% wood based (0% cotton linter) pulp vs. 100% cotton linter pulp; 100% wood based pulp vs. 33% cotton linter mixed pulp; and 33% cotton linter mixed pulp vs. 100% cotton linter pulp. The process for this study was modified in that the control and experimental specimens were dyed with two wet processing methods employed. The two different conditions are the control and two experimental specimens being included in the same dyeing vessel or the control and only one experimental specimen being included in the same dyeing vessel. The shade data is recorded in Tables 7-9, with the different methods denoted as “2-Way Comparison” or “3-Way Comparison.” The 2-way comparisons yielded better results than the 3-way comparisons in most cases.

These results are shown in Tables 7-9. In each of these Tables, if the standard and batch were designated “statistically equivalent,” this means that:
the ivory data point was below a ΔE CMC of 0.65;
the harvest gold data point was below a ΔE CMC of 1.25;
the black data point was below a ΔE CMC of 0.45;
the gray data points were all below ΔE CMC of 0.90; and
the average ΔE CMC for all gray data points was close to 0.31.

Based on the data from Tables 7-9, pulp source had a statistically significant impact on dye uptake, especially as the cotton linter pulp content is increased.

TABLE 7

| | 0% vs 33% | | | | | | | | | | | |
|---|---|---|---|---|---|---|---|---|---|---|---|---|
| | | | | | | | | | | | ΔE | Average |
| | Standard | Batch | Color | Fold | ΔL | | Δa | | Δb | | CMC | ΔE CMC |
| 3-Way | 0% CLP | 33% CLP | Ivory | A | −0.04 | darker | 0.08 | more | −0.26 | more | 0.27 | 0.32^{A} |
| Comparison | | | | | | | | red | | blue | | |
| | | | | B | 0.12 | lighter | 0.12 | more | −0.36 | more | 0.37 | |
| | | | | | | | | red | | blue | | |
| | 0% CLP | 33% CLP | Harvest | A | 0.24 | lighter | 0.00 | more | 0.10 | more | 0.15 | 0.36^{A} |
| | | | Gold | | | | | green | | yellow | | |
| | | | | B | 0.53 | lighter | −0.21 | more | 0.44 | more | 0.57 | |
| | | | | | | | | green | | yellow | | |
| | 0% CLP | 33% CLP | Black 1 | A | −0.39 | darker | 0.58 | more | −0.30 | more | 0.96 | 0.54^{B} |
| | | | | | | | | red | | blue | | |
| | | | | B | 0.06 | lighter | 0.08 | more | −0.01 | more | 0.12 | |
| | | | | | | | | red | | blue | | |
| 2-Way | 0% CLP | 33% CLP | Black 2 | A | 0.32 | lighter | 0.03 | more | 0.01 | more | 0.31 | 0.21^{A} |
| Comparison | | | | | | | | red | | yellow | | |
| | | | | B | −0.03 | darker | 0.06 | more | 0.04 | more | 0.10 | |
| | | | | | | | | red | | yellow | | |
| 3-Way | 0% CLP | 33% CLP | Gray 1 | A | −0.78 | darker | 1.16 | more | −0.59 | more | 1.77 | 1.58^{C} |
| Comparison | | | | | | | | red | | blue | | |
| | | | | B | 0.05 | lighter | 0.88 | more | −0.55 | more | 1.38 | |
| | | | | | | | | red | | blue | | |
| | 0% CLP | 33% CLP | Gray 2 | A | −1.13 | darker | 0.15 | more | −0.31 | more | 0.69 | 0.58^{A} |
| | | | | | | | | red | | blue | | |
| | | | | B | −0.33 | darker | 0.23 | more | −0.25 | more | 0.47 | |
| | | | | | | | | red | | blue | | |
| | 0% CLP | 33% CLP | Gray 3 | A | −0.83 | darker | 0.69 | more | −0.36 | more | 1.11 | 1.31^{C} |
| | | | | | | | | red | | blue | | |
| | | | | B | −1.56 | darker | 0.83 | more | −0.56 | more | 1.51 | |
| | | | | | | | | red | | blue | | |
| | 0% CLP | 33% CLP | Gray 4 | A | −0.49 | darker | 0.35 | more | −0.25 | more | 0.61 | 0.51^{A} |
| | | | | | | | | red | | blue | | |
| | | | | B | −0.30 | darker | 0.23 | more | −0.19 | more | 0.41 | |
| | | | | | | | | red | | blue | | |
| | 0% CLP | 33% CLP | Gray 5 | A | 0.06 | lighter | −0.42 | more | −0.03 | more | 0.57 | 0.51^{A} |
| | | | | | | | | green | | blue | | |
| | | | | B | −0.50 | darker | 0.17 | more | −0.23 | more | 0.44 | |
| | | | | | | | | red | | blue | | |
| 2-Way | 0% CLP | 33% CLP | Gray 6 | A | −0.54 | darker | 0.32 | more | −0.39 | more | 0.70 | 0.81^{A} |
| Comparison | | | | | | | | red | | blue | | |
| | | | | B | −0.36 | darker | 0.51 | more | −0.46 | more | 0.91 | |
| | | | | | | | | red | | blue | | |
| | 0% CLP | 33% CLP | Gray 7 | A | −0.53 | darker | 0.13 | more | −0.22 | more | 0.41 | 0.45^{A} |
| | | | | | | | | red | | blue | | |
| | | | | B | 0.49 | lighter | 0.21 | more | −0.25 | more | 0.48 | |
| | | | | | | | | red | | blue | | |
| | 0% CLP | 33% CLP | Gray 8 | A | −0.29 | darker | 0.29 | more | −0.37 | more | 0.61 | 0.70^{A} |
| | | | | | | | | red | | blue | | |
| | | | | B | −0.56 | darker | 0.38 | more | −0.43 | more | 0.78 | |
| | | | | | | | | red | | blue | | |

| | |
|---|---|
| Average ΔE CMC for all Gray Samples | 0.80 |

^{A}Statistically and practically equivalent.
^{B}Statistically different, practically equivalent.
^{C}Statistically and practically different.

TABLE 8

| | 0% vs 100% | | | | | | | | | | | |
|---|---|---|---|---|---|---|---|---|---|---|---|---|
| | | | | | | | | | | | ΔE | Average |
| | Standard | Batch | Color | Fold | ΔL | | Δa | | Δb | | CMC | ΔE CMC |
| 3-Way | 0% CLP | 100% CLP | Ivory | A | −1.11 | darker | 0.34 | more | −0.75 | more | 0.93 | 0.93^{B} |
| Comparison | | | | | | | | red | | blue | | |
| | | | | B | −0.63 | darker | 0.37 | more | −0.82 | more | 0.93 | |
| | | | | | | | | red | | blue | | |
| | 0% CLP | 100% CLP | Harvest | A | −1.24 | darker | 0.37 | more | 1.14 | more | 1.33 | 1.33^{C} |
| | | | Gold | | | | | red | | blue | | |
| | | | | B | −0.62 | darker | 0.79 | more | −0.78 | more | 1.32 | |
| | | | | | | | | red | | blue | | |
| | 0% CLP | 100% CLP | Black | A | 0.16 | lighter | 0.11 | more | −0.03 | more | 0.22 | 0.51^{B} |
| | | | | | | | | red | | blue | | |
| | | | | B | −0.24 | darker | 0.52 | more | −0.22 | more | 0.80 | |
| | | | | | | | | red | | blue | | |
| | 0% CLP | 100% CLP | Gray 1 | A | −1.01 | darker | 0.50 | more | −1.02 | more | 1.56 | 1.53^{C} |
| | | | | | | | | red | | blue | | |
| | | | | B | −0.63 | darker | 0.51 | more | −0.99 | more | 1.49 | |
| | | | | | | | | red | | blue | | |
| | 0% CLP | 100% CLP | Gray 2 | A | −1.44 | darker | 0.64 | more | −1.06 | more | 1.72 | 1.61^{C} |
| | | | | | | | | red | | blue | | |
| | | | | B | −0.69 | darker | 0.54 | more | −1.01 | more | 1.50 | |
| | | | | | | | | red | | blue | | |
| | 0% CLP | 100% CLP | Gray 3 | A | −1.64 | darker | 0.87 | more | −1.07 | more | 1.97 | 2.09^{C} |
| | | | | | | | | red | | blue | | |
| | | | | B | −1.02 | darker | 1.06 | more | −1.25 | more | 2.20 | |
| | | | | | | | | red | | blue | | |
| | 0% CLP | 100% CLP | Gray 4 | A | −1.08 | darker | 0.02 | more | −0.74 | more | 1.06 | 0.98^{B} |
| | | | | | | | | red | | blue | | |
| | | | | B | −0.28 | darker | 0.11 | more | −0.68 | more | 0.89 | |
| | | | | | | | | red | | blue | | |
| | 0% CLP | 100% CLP | Gray 5 | A | −0.86 | darker | 0.47 | more | −0.75 | more | 1.20 | 1.14^{C} |
| | | | | | | | | red | | blue | | |
| | | | | B | −1.45 | darker | 0.17 | more | −0.64 | more | 1.08 | |
| | | | | | | | | red | | blue | | |

| | |
|---|---|
| Average ΔE CMC for all Gray Samples | 1.47 |

^{B}Statistically different, practically equivalent.
^{C}Statistically and practically different.

TABLE 9

| | 33% vs 100% | | | | | | | | | | | |
|---|---|---|---|---|---|---|---|---|---|---|---|---|
| | | | | | | | | | | | ΔE | Average |
| | Standard | Batch | Color | Fold | ΔL | | Δa | | Δb | | CMC | ΔE CMC |
| 3-Way | 33% CLP | 100% CLP | Ivory | A | −0.65 | darker | 0.08 | more | −0.17 | more | 0.30 | 0.29^{A} |
| Comparison | | | | | | | | red | | blue | | |
| | | | | B | −0.53 | darker | 0.11 | more | −0.13 | more | 0.28 | |
| | | | | | | | | red | | blue | | |
| | 33% CLP | 100% CLP | Harvest | A | −1.38 | darker | 0.09 | more | −1.04 | more | 1.10 | 1.43^{C} |
| | | | Gold 1 | | | | | red | | blue | | |
| | | | | B | −1.51 | darker | 0.59 | more | −1.43 | more | 1.76 | |
| | | | | | | | | red | | blue | | |
| 2-Way | 33% CLP | 100% CLP | Harvest | A | −0.50 | darker | −0.35 | more | −0.65 | more | 0.41 | 0.44^{A} |
| Comparison | | | Gold 2 | | | | | green | | blue | | |
| | | | | B | 0.02 | lighter | 0.10 | more | −0.51 | more | 0.46 | |
| | | | | | | | | red | | blue | | |
| 3-Way | 33% CLP | 100% CLP | Black 1 | A | −0.53 | darker | 0.53 | more | −0.14 | more | 0.90 | 0.85^{B} |
| Comparison | | | | | | | | red | | blue | | |
| | | | | B | −0.46 | darker | 0.47 | more | −0.10 | more | 0.79 | |
| | | | | | | | | red | | blue | | |
| 2-Way | 33% CLP | 100% CLP | Black 2 | A | 0.37 | lighter | 0.17 | more | −0.17 | more | 0.49 | 0.56^{B} |
| Comparison | | | | | | | | red | | blue | | |
| | | | | B | 0.49 | lighter | 0.22 | more | −0.19 | more | 0.62 | |
| | | | | | | | | red | | blue | | |
| 3-Way | 33% CLP | 100% CLP | Gray 1 | A | −0.55 | darker | −0.64 | more | −0.33 | more | 0.99 | 0.91^{B} |
| Comparison | | | | | | | | green | | blue | | |
| | | | | B | 0.04 | lighter | 0.00 | more | −0.66 | more | 0.82 | |
| | | | | | | | | red | | blue | | |
| | 33% CLP | 100% CLP | Gray 2 | A | 0.13 | lighter | −0.20 | more | −0.59 | more | 0.79 | 0.89^{A} |
| | | | | | | | | green | | blue | | |
| | | | | B | −0.67 | darker | 0.14 | more | −0.74 | more | 0.99 | |
| | | | | | | | | red | | blue | | |
| | 33% CLP | 100% CLP | Gray 3 | A | −0.66 | darker | 0.19 | more | −0.63 | more | 0.88 | 1.01^{C} |
| | | | | | | | | red | | blue | | |
| | | | | B | −1.50 | darker | 0.26 | more | −0.67 | more | 1.14 | |
| | | | | | | | | red | | blue | | |
| | 33% CLP | 100% CLP | Gray 4 | A | −0.79 | darker | −0.38 | more | −0.51 | more | 0.90 | 0.84^{A} |
| | | | | | | | | green | | blue | | |
| | | | | B | −0.54 | darker | −0.26 | more | −0.51 | more | 0.78 | |
| | | | | | | | | green | | blue | | |
| | 33% CLP | 100% CLP | Gray 5 | A | −0.79 | darker | −0.15 | more | −0.42 | more | 0.67 | 0.63^{A} |
| | | | | | | | | green | | blue | | |
| | | | | B | −0.39 | darker | −0.15 | more | −0.43 | more | 0.59 | |
| | | | | | | | | green | | blue | | |
| 2-Way | 33% CLP | 100% CLP | Gray 6 | A | −0.77 | darker | 0.25 | more | −0.60 | more | 0.90 | 0.93^{B} |
| Comparison | | | | | | | | red | | blue | | |
| | | | | B | −0.83 | darker | 0.30 | more | −0.62 | more | 0.96 | |
| | | | | | | | | red | | blue | | |
| | 33% CLP | 100% CLP | Gray 7 | A | −0.80 | darker | 0.23 | more | −0.54 | more | 0.83 | 0.83^{A} |
| | | | | | | | | red | | blue | | |
| | | | | B | 0.24 | lighter | 0.34 | more | −0.55 | more | 0.82 | |
| | | | | | | | | red | | blue | | |

| | |
|---|---|
| Average ΔE CMC for all Gray Samples | 0.86 |

^{A}Statistically and practically equivalent.
^{B}Statistically different, practically equivalent.
^{C}Statistically and practically different.

### CLAIMS NOT LIMITED TO DISCLOSED EMBODIMENTS

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A process comprising reacting an esterification agent with cellulose to form a cellulose ester, wherein at least a portion of said cellulose is derived from a first waste material and at least a portion of said esterification agent is derived from a second waste material, wherein said cellulose ester has recycled content from said cellulose and said esterification agent.

2. The process according to claim 1, wherein said first waste material is textile waste and said second waste material is waste plastic.

3. The process according to claim 1, wherein the total recycled content of said cellulose ester is at least 20 percent, at least 40 percent, at least 50 percent, or at least about 60 percent.

4. A process for making recycled content cellulose ester fibers, said process comprising:
(a) providing a first raw material having recycled content derived from textile waste;
(b) providing a second raw material having recycled content derived from waste plastic;
(c) synthesizing a recycled content cellulose ester material from at least said first raw material and said second raw material, wherein said recycled content cellulose ester material has recycled content derived from textile waste and waste plastic; and
(d) spinning said recycled content cellulose ester material to produce recycled content cellulose ester fibers having recycled content derived from textile waste and waste plastic.

5. The process of claim 4, wherein the total recycled content of said recycled content cellulose ester fibers is at least 20 percent, at least 40 percent, at least 50 percent, or at least about 60 percent.

6. The process of claim 4, wherein said recycled content cellulose ester fibers comprise at least 10 percent, at least 20 percent, at least 30 percent, or at least about 40 percent recycled content derived from textile waste and at least 5 percent, at least 10 percent, at least 15 percent, or at least about 20 percent recycle content derived from waste plastic.

7. A process for making recycled content cellulose ester fibers, said process comprising:
(a) esterifying a recycled content cellulose with a recycled content esterification agent to thereby produce an initial cellulose ester material having recycled content from said recycled content cellulose and said recycled content esterification agent;
(b) optionally, hydrolyzing said initial cellulose ester material to thereby produce a hydrolyzed cellulose ester material; and
(c) spinning at least one of said initial cellulose ester material and said hydrolyzed cellulose ester material to thereby produce recycled content cellulose ester fibers having recycled content from said recycled content cellulose and said recycled content esterification agent.

8. A recycled content cellulose ester fiber formed from a cellulose ester material have repeating units of the following structure: 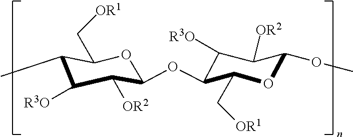
wherein the six membered rings are glucose rings,
wherein R¹, R², and R³ are selected independently from the group consisting of hydrogen or straight chain alkanoyls having from 2 to 10 carbon atoms,
wherein the DS_{acetyl} of said cellulose ester material is in the range of 1.5 to 2.95, 2.0 to 2.65, or 2.25 to 2.55,
wherein the DS_{OH} of said cellulose ester material is in the range of 0.5 to 1.5, 0.3 to 1.4, or 2.25 to 2.55,
wherein at least a portion, at least 10 percent, at least 20, percent, at least 40 percent, at least 60 percent, at least 80 percent, at least 90 percent, or 100 percent of said alkanoyls are recycled content alkanoyls derived from waste plastic,
wherein at least a portion, at least 10 percent, at least 20, percent, at least 40 percent, at least 60 percent, at least 80 percent, at least 90 percent, or 100 percent of said glucose rings are recycled content glucose rings derived from textile waste.

9. The recycled content cellulose ester fiber of claim 8, wherein at least a portion of said glucose rings are non-recycled content glucose rings.

10. The recycled content cellulose ester fiber of claim 8, wherein the ratio of non-recycled content glucose rings to recycled content glucose rings is in the range of 0.1:1 to 10:1, 0.5:1 to 5:1, 1:1 to 4:1, 1.5:1 to 3:1, or about 2:1.

11. The recycled content cellulose ester fiber of claim 8, wherein said non-recycled content glucose rings are derived from a renewable material.

12. The recycled content cellulose ester fiber of claim 11, wherein said renewable material is wood pulp.

13. The recycled content cellulose ester fiber of claim 8, wherein the total recycled content of said recycled content cellulose ester fiber is at least 20 percent, at least 40 percent, at least 50 percent, or at least about 60 percent.

14. The recycled content cellulose ester fiber of claim 13, wherein said recycled content cellulose ester fiber comprises at least 10 percent, at least 20 percent, at least 30 percent, or at least about 40 percent recycled content derived from textile waste and at least 5 percent, at least 10 percent, at least 15 percent, or at least about 20 percent recycle content derived from waste plastic.

15. The recycled content cellulose ester fiber of claim 8, wherein said textile waste is pre-consumer textile waste.

16. The recycled content cellulose ester fiber of claim 15, wherein said pre-consumer textile waste is chosen from cotton linters, undercard, fabric clippings, cattle feed waste, comber knolls, pneumafil waste, shoddy waste, yarn waste, production waste, cutter clippings, twisting waste, or mixtures of two or more thereof.

17. The recycled content cellulose ester fiber of claim 8, wherein the waste plastic is post-consumer waste plastic.

18. The recycled content cellulose ester fiber of claim 8, wherein the total degree of substitution (DS) of said recycled content cellulose ester fiber is in the range of 1.5 to 2.95, 2.0 to 2.65, or 2.25 to 2.55.

19. The recycled content cellulose ester fiber of claim 8, wherein said recycled content cellulose ester fiber has a denier per filament (dpf) in the range of 0.5 to 30.

20. An article comprising a cellulose ester fiber formed according to claim 8.
